(19) United States
(12) Patent Application Publication
(10) Pub. No.: US 2013/0290018 A1
(43) Pub. Date: Oct. 31, 2013

(54) HEALTH CARE DELIVERY VERIFICATION METHODS, APPARATUS, AND SYSTEMS

(71) Applicants: Daniel D. Anderson, Madison, WI (US); Sherman L. Bartz, St. Paul, MN (US); Craig M. Carlson, Vadnais Heights, MN (US); Orlin B. Knudson, Vadnais Heights, MN (US); John M. Kruse, Minneapolis, MN (US); Mary E. Kundus, Hudson, WI (US)

(72) Inventors: Daniel D. Anderson, Madison, WI (US); Sherman L. Bartz, St. Paul, MN (US); Craig M. Carlson, Vadnais Heights, MN (US); Orlin B. Knudson, Vadnais Heights, MN (US); John M. Kruse, Minneapolis, MN (US); Mary E. Kundus, Hudson, WI (US)

(73) Assignee: 3M INNOVATIVE PROPERTIES COMPANY, Saint Paul, MN (US)

(21) Appl. No.: 13/995,087

(22) PCT Filed: Dec. 27, 2011
(86) PCT No.: PCT/US2011/067360

§ 371 Date: Jun. 17, 2013

Related U.S. Application Data
(60) Provisional application No. 61/428,621, filed on Dec. 30, 2010.

(51) Int. Cl. G06Q 50/22; G06Q 30/00

(52) U.S. Cl. CPC G06Q 50/22; G06Q 30/018
USPC 705/2

(57) ABSTRACT

Methods, apparatus and systems for verifying proper delivery of health care bundles to patients are described. The methods, apparatus, and systems may be configured to monitor the delivery of health care bundles to one or more patients, to collect delivery data such as sounds and/or images that can be processed to determine if delivery of the health care bundle is being or has been properly delivered to a patient, to provide feedback during delivery of a health care bundle to a patient, and/or to store an indicator that is indicative of proper delivery of the health care bundle.

Methods, apparatus, and systems of verifying proper delivery of health care in the form of health care bundles are described herein

Health care Associated Infections (HAI) are a significant issue. Common HAIs include surgical site infections (SSIs), blood stream infections (BSIs), urinary tract infections (UTIs), ventilator associated pneumonia (VAP), and horizontally spread infections such as MRSA.

Improvement of health care outcomes can, in many instances, be influenced by the practices used to deliver the care to patients. In the fast-paced, high stress environment encountered in many health care facilities, however, the uniform and effective delivery of health care can be compromised. Although some health care facilities may provide training and re-training to health care workers to improve the delivery of health care, such attempts are time-consuming, labor-intensive and, therefore, costly. Furthermore, the health care delivery practices are subject to continual changes as those practices are adapted in attempts to improve patient outcomes, thus necessitating further training and re-training.

### SUMMARY

Methods, apparatus and systems for verifying proper delivery of health care bundles to patients are described herein. In various embodiments, the methods, apparatus, and systems may be used to monitor the delivery of health care bundles to one or more patients. The methods, apparatus, and systems may, in some embodiments, be configured to collect delivery data such as sounds and/or images that can be processed to determine if delivery of the health care bundle is being or has been properly delivered to a patient. In some embodiments, the methods, apparatus, and systems may be configured to provide feedback during delivery of a health care bundle to a patient. The methods, apparatus, and systems described herein may, in some embodiments, be configured to store an indicator that is indicative of proper delivery of the health care bundle.

One potential advantage of some embodiments of the methods, apparatus, and systems described herein may include, for example, more uniform delivery of health care bundles to patients. Another potential advantage of some embodiments of the methods, apparatus, and systems described herein is the ability to collect delivery data and use that data to provide feedback regarding proper or improper delivery of the health care bundles during the health care bundle delivery process. The feedback delivered as a part of the verification process as described herein may allow a person delivering a health care bundle to correct errors made during the delivery process and/or reduce the likelihood that the same errors will be made in delivery the same health care bundle to a subsequent patient.

The “health care bundles” described herein are used in the delivery of health care to patients, where a health care bundle may be defined as “a group of interventions (practices) related to a disease process that, when executed together, result in better outcomes than when implemented individually.” As used herein, a health care bundle will typically, but not necessarily, include one or more physical items, a process that involves use of the one or more physical items, and, optionally, monitoring of the process of using the one or more physical items. Monitoring of the process may include monitoring the time between performance of different steps within a specific health care bundle delivery sequence and/or the time between delivery of discrete health care bundles. Health care bundles may be used throughout patient care, i.e., in the pre-, peri, and post-operative stages of health care.

The physical items of a health care bundle may include a kit (e.g., disposables such as catheters, alcohol wipes, drapes, hand cleaners, etc.), instruments (stethoscopes, environmental monitors, blood pressure monitors, etc.), or dispensers (hand sanitizer dispensers, sterile wipes, etc.). The processes included in health care bundles are steps used in delivering the health care associated with the health care bundle to a patient.

Health care bundles may be established for use with the delivery of almost any health care to a patient, including, but not limited to, e.g., urinary catheter care, intravenous catheter care, endotracheal tube care, instrument monitoring, delivery of medication, vital sign monitoring, environmental monitoring, etc.

As one example of a health care bundle, endotracheal tubes are used in combination with ventilators to assist patient respiration and may be the source of VAP (Ventilator Associated Pneumonia). A health care bundle for insertion of an endotracheal tube (sometimes referred to as a “VAP bundle”) may include physical items for providing oral care to the patient, as well as instructions regarding the processes to be implemented as part of the health care bundle (which may or may not actually involve use of the physical items in the health care bundle). Other health care bundles may be established for almost any other care to be provided to a patient.

The health care bundles and the delivery protocols associated with proper delivery of the health care bundles can vary between different health care facilities. Further, the health care bundles and the delivery protocols associated with proper delivery of any health care bundle within a given health care facility may change based on the patient (based on, e.g., the patient's age, condition, etc.), the health care worker delivering the health care bundle, changes in recommended practices, etc. In other words, the health care facilities may change the health care bundles and the delivery protocols based on any factor, i.e., improvement in patient outcomes, reducing costs without negatively affecting patient outcomes, etc. The methods, apparatus, and systems described herein can preferably be adapted to accommodate any such variations between different health care facilities, patients, etc. in the proper delivery protocols associated with health care bundles.

In a first aspect, some embodiments of a method of verifying delivery of a health care bundle to a patient as described herein may include: registering a health care bundle to be delivered to a selected patient using a verification unit; determining if the registered health care bundle should be delivered to the selected patient; and providing a registration feedback signal using the verification unit after determining if the registered health care bundle should be delivered to the selected patient, wherein the registration feedback signal comprises at least one of: a confirmation signal if the registered health care bundle should be delivered to the selected patient, and a corrective signal if the registered health care bundle should not be delivered to the selected patient. The method may further include collecting delivery data during delivery of the registered health care bundle to the selected patient, wherein the delivery data comprises sound associated with delivery of the registered health care bundle; determining if the sound collected during delivery of the registered health care bundle comprises one or more selected audio signatures that are associated with proper delivery of the registered health care bundle, wherein each selected audio signature comprises either a selected speech pattern spoken during delivery of the registered health care bundle or a selected non-speech pattern collected during delivery of the registered health care bundle; and providing a delivery feedback signal using the verification unit after determining if the sound comprises the one or more selected audio signatures, wherein the feedback signal comprises at least one of: a corrective signal if the sound does not include at least one selected audio signature associated with proper delivery of the registered health care bundle, and a confirmation signal if the sound includes at least one selected audio signature associated with proper delivery of the registered health care bundle. The method may further include storing an indicator that is indicative of at least one of the selected audio signatures found in the sound collected during delivery of the registered health care bundle.

In another aspect, some embodiments of a method of verifying delivery of a health care bundle to a patient as described herein may include registering a health care bundle to be delivered to a selected patient; publishing selected information associated with the registered health care bundle using a verification unit; collecting delivery data during delivery of the registered health care bundle to the selected patient, wherein the delivery data comprises sound associated with delivery of the registered health care bundle; determining if the sound collected during delivery of the registered health care bundle comprises one or more selected audio signatures that are associated with proper delivery of the registered health care bundle, wherein each selected audio signature comprises either a selected speech pattern spoken during delivery of the registered health care bundle or a selected non-speech pattern collected during delivery of the registered health care bundle; and providing a delivery feedback signal using the verification unit after determining if the sound comprises the one or more selected audio signatures, wherein the feedback signal comprises at least one of: a corrective signal if the sound does not include at least one selected audio signature associated with proper delivery of the registered health care bundle, and a confirmation signal if the sound includes at least one selected audio signature associated with proper delivery of the registered health care bundle. The method may further include storing an indicator that is indicative of at least one of the selected audio signatures found in the sound collected during delivery of the registered health care bundle.

In another aspect, some embodiments of a method of verifying delivery of a health care bundle to a patient as described herein may include: registering a health care bundle to be delivered to a selected patient using a verification unit; determining if the registered health care bundle should be delivered to the selected patient; and providing a registration feedback signal using the verification unit after determining if the registered health care bundle should be delivered to the selected patient, wherein the registration feedback signal comprises at least one of: a confirmation signal if the registered health care bundle should be delivered to the selected patient, and a corrective signal if the registered health care bundle should not be delivered to the selected patient. The method may further include collecting delivery data during delivery of the registered health care bundle to the selected patient, wherein the delivery data comprises one or more images associated with delivery of the registered health care bundle; determining if the one or more images collected during delivery of the registered health care bundle comprise a selected object that is associated with proper delivery of the registered health care bundle; and providing a delivery feedback signal using the verification unit after determining if the one or more images collected during delivery of the registered health care bundle comprises the selected object, wherein the feedback signal comprises at least one of: a corrective signal if the one or more images do not include the selected object associated with proper delivery of the registered health care bundle, and a confirmation signal if the one or more images include the selected object associated with proper delivery of the registered health care bundle. The method may further include storing an indicator that is indicative of at least one selected object associated with proper delivery of the registered health care bundle found in the one or more images collected during delivery of the registered health care bundle.

In another aspect, some embodiments of a method of verifying delivery of a health care bundle to a patient as described herein may include: registering a health care bundle to be delivered to a selected patient; publishing selected information associated with the registered health care bundle using a verification unit; collecting delivery data during delivery of the registered health care bundle to the selected patient, wherein the delivery data comprises one or more images associated with delivery of the registered health care bundle; determining if the one or more images collected during delivery of the registered health care bundle comprise a selected object that is associated with proper delivery of the registered health care bundle; and providing a delivery feedback signal using the verification unit after determining if the one or more images collected during delivery of the registered health care bundle comprises the selected object, wherein the feedback signal comprises at least one of: a corrective signal if the one or more images do not include the selected object associated with proper delivery of the registered health care bundle, and a confirmation signal if the one or more images include the selected object associated with proper delivery of the registered health care bundle. The method may further include storing an indicator that is indicative of at least one selected object associated with proper delivery of the registered health care bundle found in the one or more images collected during delivery of the registered health care bundle.

In some embodiments of the methods described herein, the verification unit comprises a microphone and an audio signal processor, wherein the microphone and the audio signal processor are configured to collect sound during delivery of the registered health care bundle and to process the collected sound to determine if the sound comprises the one or more selected audio signatures associated with proper delivery of the registered health care bundle.

In some embodiments of the methods described herein, the verification unit comprises a microphone and an audio signal processor, wherein the microphone and the audio signal processor are configured to transmit the sound collected during delivery of the registered health care bundle to a remote audio signal processor, wherein the remote audio signal processor is configured to process the sound collected by the verification unit to determine if the sound comprises the one or more selected audio signatures associated with proper delivery of the registered health care bundle.

In some embodiments of the methods described herein, a supplemental audio collection device collects at least a portion of the sound collected during delivery of the registered health care bundle. In some embodiments, the supplemental audio collection device comprises a stethoscope.

In some embodiments of the methods described herein, a selected non-speech pattern identified in the sound collected during delivery of the registered health care bundle comprises one or more of: sound produced by running water, sound produced when operating a hand sanitizer dispenser, sound in a frequency range above 20 kiloHertz, and sound produced when opening a selected package.

In some embodiments of the methods described herein, the stored indicator comprises text data.

In some embodiments of the methods described herein, if the one or more images collected during delivery of the registered health care bundle comprises a selected object, the stored indicator comprises at least a portion of the image that contains the selected object.

In some embodiments of the methods described herein, if the one or more images collected during delivery of the registered health care bundle comprises a selected object, the stored indicator comprises a representative image associated with the selected object, wherein the representative image is not the image collected during delivery of the registered health care bundle.

In some embodiments of the methods described herein, if a selected audio signature in the sound collected during delivery of the registered health care bundle comprises a selected speech pattern, the stored indicator comprises text data derived from the selected speech pattern.

In some embodiments of the methods described herein, if the selected audio signature in the sound collected during delivery of the registered health care bundle comprises a selected non-speech pattern, the stored indicator comprises at least a portion of the sound collected by the verification unit that contains the selected non-speech pattern.

In some embodiments of the methods described herein, if the selected audio signature in the sound collected during delivery of the registered health care bundle comprises a selected non-speech pattern, the stored indicator comprises a representative sound associated with the selected non-speech pattern, wherein the representative sound is not the sound collected during delivery of the registered health care bundle.

In some embodiments of the methods described herein, if the one or more selected audio signatures in the sound collected during delivery of the health care bundle comprise two selected audio signatures, the method further comprises: determining if the two selected audio signatures occur in a selected order and/or within a selected period of time that is associated with proper delivery of the registered health care bundle; providing a delivery feedback signal using the verification unit after determining if the two selected audio signatures occur in the selected order and/or within the selected period of time, wherein the delivery feedback signal comprises at least one of: a confirmation signal if the two selected audio signatures occur in the selected order and/or within the selected period of time that is associated with proper delivery of the registered health care bundle; and a corrective signal if the two selected audio signatures do not occur in the selected order and/or within the selected period of time that is associated with proper delivery of the registered health care bundle.

In some embodiments of the methods described herein, if the one or more selected audio signatures in the sound collected during delivery of the health care bundle comprise two selected audio signatures that comprise a selected speech pattern and a selected non-speech pattern, the method further comprises: determining if the selected speech pattern and the selected non-speech pattern occur in a selected order and/or within a selected period of time that is associated with proper delivery of the registered health care bundle; providing a delivery feedback signal using the verification unit after determining if the selected speech pattern and the selected non-speech pattern occur in the selected order and/or within the selected period of time, wherein the delivery feedback signal comprises at least one of: a confirmation signal if the selected speech pattern and the selected non-speech pattern occur in the selected order and/or within the selected period of time that is associated with proper delivery of the registered health care bundle, and a corrective signal if the selected speech pattern and the selected non-speech pattern do not occur in the selected order and/or within the selected period of time that is associated with proper delivery of the registered health care bundle.

In some embodiments of the methods described herein, if one or more selected audio signatures in the sound collected during delivery of the health care bundle comprises two selected speech patterns, the method further comprises: determining if the two selected speech patterns occur in a selected order and/or within a selected period of time that is associated with proper delivery of the registered health care bundle; providing a delivery feedback signal using the verification unit after determining if the two selected speech patterns occur in the selected order and/or within the selected period of time, wherein the delivery feedback signal comprises at least one of: a confirmation signal if the two selected speech patterns are in the selected order and/or within the selected period of time that is associated with proper delivery of the registered health care bundle, and a corrective signal if the two selected speech patterns do not occur in the selected order and/or within the selected period of time that is associated with proper delivery of the registered health care bundle.

In some embodiments of the methods described herein, if the one or more selected audio signatures in the sound collected during delivery of the health care bundle comprise two selected speech patterns and a selected non-speech pattern, the method further comprises: determining if the two selected speech patterns and the selected non-speech pattern occur in a selected order that is associated with proper delivery of the registered health care bundle; providing a delivery feedback signal using the verification unit after determining if the two selected speech patterns and the selected non-speech pattern occur in the selected order, wherein the delivery feedback signal comprises at least one of: a confirmation signal if the two selected speech patterns and the selected non-speech pattern are in the selected order that is associated with proper delivery of the registered health care bundle, and a corrective signal if the two selected speech patterns and the selected non-speech pattern do not occur in the selected order that is associated with proper delivery of the registered health care bundle.

In some embodiments of the methods described herein, collecting delivery data during delivery of the registered health care bundle to the selected patient comprises: collecting one or more images associated with delivery of the registered health care bundle; determining if the one or more images collected during delivery of the registered health care bundle comprise a selected object that is associated with proper delivery of the registered health care bundle; providing a delivery feedback signal using the verification unit after determining if the one or more images collected during delivery of the registered health care bundle comprises the selected object, wherein the feedback signal comprises at least one of: a corrective signal if the one or more images do not include the selected object associated with proper delivery of the registered health care bundle, and a confirmation signal if the one or more images include the selected object associated with proper delivery of the registered health care bundle; and storing an indicator that is indicative of at least one selected object associated with proper delivery of the registered health care bundle found in the one or more images collected during delivery of the registered health care bundle.

In some embodiments of the methods described herein in which images are collected as delivery data, the verification unit comprises a camera and an image processor, wherein the camera and the image processor are configured to collect images during delivery of the registered health care bundle and to process the collected images to determine if the one or more images comprise the selected object associated with proper delivery of the registered health care bundle.

In some embodiments of the methods described herein in which images are collected as delivery data, the verification unit comprises a camera and an image processor, wherein the camera and the image processor are configured to transmit the one or more images collected during delivery of the registered health care bundle to a remote image processor, wherein the remote image processor is configured to process the collected images to determine if the one or more images comprise the selected object associated with proper delivery of the registered health care bundle.

In some embodiments of the methods described herein in which images are collected as delivery data, a supplemental image collection device collects at least one image of the one or more images collected during delivery of the registered health care bundle. In some embodiments, the supplemental image collection device is selected from a group consisting of an ultrasonic imaging device, an imaging otoscope, a barcode scanner, a cell phone, and combinations thereof.

In some embodiments of the methods described herein in which images are collected as delivery data, if the delivery data collected during delivery of the registered health care bundle comprises a selected audio signature and a selected object, the method further comprises: determining if the selected audio signature and the image comprising the selected object were collected in a selected order and/or within a selected period of time that is associated with proper delivery of the registered health care bundle; providing a delivery feedback signal using the verification unit after determining if the selected audio signature and an image comprising the selected object were collected in the selected order and/or within the selected period of time, wherein the delivery feedback signal comprises at least one of: a confirmation signal if the selected audio signature and the image comprising the selected object were collected in the selected order and/or within the selected period of time that is associated with proper delivery of the registered health care bundle, and a corrective signal if the selected audio signature and the image comprising the selected object were not collected in the selected order and/or within the selected period of time that is associated with proper delivery of the registered health care bundle.

In some embodiments of the methods described herein in which images are collected as delivery data, if the delivery data collected during delivery of the registered health care bundle comprises a selected speech pattern and an image comprising a selected object, the method further comprises: determining if the selected speech pattern and the image comprising the selected object were collected in a selected order and/or within a selected period of time that is associated with proper delivery of the registered health care bundle; providing a delivery feedback signal using the verification unit after determining if the selected speech pattern and the image comprising the selected object were collected in the selected order and/or within the selected period of time, wherein the delivery feedback signal comprises at least one of: a confirmation signal if the selected speech pattern and the image comprising the selected object were collected in the selected order and/or within the selected period of time that is associated with proper delivery of the registered health care bundle, and a corrective signal if the selected speech pattern and the image comprising the selected object were not collected in the selected order and/or within the selected period of time that is associated with proper delivery of the registered health care bundle.

In some embodiments of the methods described herein in which images are collected as delivery data, if the delivery data collected during delivery of the registered health care bundle comprises a selected non-speech pattern and an image comprising a selected object, the method further comprises: determining if the selected non-speech pattern and the image comprising the selected object were collected in a selected order and/or within a selected period of time that is associated with proper delivery of the registered health care bundle; providing a delivery feedback signal using the verification unit after determining if the selected non-speech pattern and the image comprising the selected object were collected in the selected order and/or within the selected period of time, wherein the delivery feedback signal comprises at least one of: a confirmation signal if the selected non-speech pattern and the image comprising the selected object were collected in the selected order and/or within the selected period of time that is associated with proper delivery of the registered health care bundle, and a corrective signal if the selected non-speech pattern and the image comprising the selected object were not collected in the selected order and/or within the selected period of time that is associated with proper delivery of the registered health care bundle.

In some embodiments of the methods described herein, registering the registered health care bundle to be delivered to the selected patient comprises: collecting sound as a part of registering the health care bundle; and determining if the sound collected as a part of registering the health care bundle comprises a selected speech pattern that is associated with identification of the health care bundle.

In some embodiments of the methods described herein, registering the health care bundle to be delivered to the selected patient comprises obtaining bundle data from a bundle credential associated with the selected health care bundle.

In some embodiments of the methods described herein, registering the health care bundle to be delivered to the selected patient comprises obtaining the bundle data associated with the selected health care bundle by scanning optical indicia on the bundle credential associated with the selected health care bundle.

In some embodiments of the methods described herein, registering the health care bundle to be delivered to the selected patient comprises obtaining an image associated with the selected health care bundle and determining if the image contains a selected object associated with identification of the selected health care bundle.

In some embodiments of the methods described herein, the method further comprises publishing selected information associated with the registered health care bundle using the verification unit. In some embodiments, the selected information comprises at least one instruction for delivering the registered health care bundle to the selected patient. In some embodiments, the selected information is stored in the verification unit before registering the health care bundle. In some embodiments, the selected information is delivered to the verification unit after registering the health care bundle.

In some embodiments of the methods described herein, if the one or more images collected during delivery of the health care bundle comprise two images, each of which contains a selected object associated with proper delivery of the registered health care bundle, the method further comprises: determining if the two images were collected in a selected order and/or within a selected period of time that is associated with proper delivery of the registered health care bundle; providing a delivery feedback signal using the verification unit after determining if the two images were collected in the selected order and/or within the selected period of time, wherein the delivery feedback signal comprises at least one of: a confirmation signal if the two images were collected in the selected order and/or within the selected period of time that is associated with proper delivery of the registered health care bundle; and a corrective signal if the two images were not collected in the selected order and/or within the selected period of time that is associated with proper delivery of the registered health care bundle.

In another aspect, some embodiments of a system for verifying delivery of a health care bundle to a patient as described herein may include a plurality of verification units operably connected to a central controller through a communication network in a health care facility. Each of the verification units may include: registration apparatus configured to register a health care bundle to be delivered to a selected patient; feedback signal apparatus configured to deliver a feedback signal capable of detection by a person proximate the verification unit; and a delivery data collector configured to collect delivery data in the form of sound during delivery of a health care bundle. The system may be configured to: determine if the registered health care bundle should be delivered to the selected patient; provide a registration feedback signal using the feedback signal apparatus of the verification unit after determining if the registered health care bundle should be delivered to the selected patient; determine if sound collected by the verification unit comprises one or more selected audio signatures that are associated with proper delivery of the registered health care bundle, wherein each selected audio signature comprises either a selected speech pattern spoken during delivery of the registered health care bundle or a selected non-speech pattern collected during delivery of the registered health care bundle; provide a delivery feedback signal using the feedback signal apparatus of the verification unit after determining if the sound comprises one or more of the selected audio signatures; and store an indicator that is indicative of at least one of any of the selected audio signatures found in the sound collected during delivery of the registered health care bundle.

In another aspect, some embodiments of a system for verifying delivery of a health care bundle to a patient as described herein may include a plurality of verification units operably connected to a central controller through a communication network in a health care facility. Each of the verification units may include: publication apparatus configured to publish selected information associated with a registered health care bundle to a person proximate the verification unit; feedback signal apparatus configured to deliver a feedback signal capable of detection by a person proximate the verification unit; and a delivery data collector configured to collect delivery data in the form of sound during delivery of a health care bundle. The system is configured to: determine if the registered health care bundle should be delivered to the selected patient; provide a registration feedback signal using the feedback signal apparatus of the verification unit after determining if the registered health care bundle should be delivered to the selected patient; determine if sound collected by the verification unit comprises one or more selected audio signatures that are associated with proper delivery of the registered health care bundle, wherein each selected audio signature comprises either a selected speech pattern spoken during delivery of the registered health care bundle or a selected non-speech pattern collected during delivery of the registered health care bundle; provide a delivery feedback signal using the feedback signal apparatus of the verification unit after determining if the sound comprises one or more of the selected audio signatures; and store an indicator that is indicative of at least one of any of the selected audio signatures found in the sound collected during delivery of the registered health care bundle.

In another aspect, some embodiments of the systems for verifying delivery of a health care bundle to a patient as described herein may include a plurality of verification units operably connected to a central controller through a communication network in a health care facility. Each of the verification units may include: registration apparatus configured to register a health care bundle to be delivered to a selected patient; feedback signal apparatus configured to deliver a feedback signal capable of detection by a person proximate the verification unit; and a delivery data collector configured to collect delivery data in the form of one or more images associated with delivery of the registered health care bundle during delivery of a health care bundle. The system is configured to: determine if the registered health care bundle should be delivered to the selected patient; provide a registration feedback signal using the feedback signal apparatus of the verification unit after determining if the registered health care bundle should be delivered to the selected patient; determine if the one or more images collected during delivery of the registered health care bundle comprise a selected object that is associated with proper delivery of the registered health care bundle; provide a delivery feedback signal using the feedback signal apparatus of the verification unit after determining if the one or more images collected during delivery of the registered health care bundle comprises the selected object; and store an indicator that is indicative of a selected object associated with proper delivery of the registered health care bundle found in the one or more images collected during delivery of the registered health care bundle.

In another aspect, some embodiments of the systems for verifying delivery of a health care bundle to a patient as described herein may include a plurality of verification units operably connected to a central controller through a communication network in a health care facility. Each of the verification units may include: publication apparatus configured to publish selected information associated with a registered health care bundle to a person proximate the verification unit; feedback signal apparatus configured to deliver a feedback signal capable of detection by a person proximate the verification unit; and a delivery data collector configured to collect delivery data in the form of one or more images associated with delivery of the registered health care bundle during delivery of a health care bundle. The system is configured to: determine if the registered health care bundle should be delivered to the selected patient; provide a registration feedback signal using the feedback signal apparatus of the verification unit after determining if the registered health care bundle should be delivered to the selected patient; determine if the one or more images collected during delivery of the registered health care bundle comprise a selected object that is associated with proper delivery of the registered health care bundle; provide a delivery feedback signal using the feedback signal apparatus of the verification unit after determining if the one or more images collected during delivery of the registered health care bundle comprises the selected object; and store an indicator that is indicative of a selected object associated with proper delivery of the registered health care bundle found in the one or more images collected during delivery of the registered health care bundle.

In some embodiments of the systems described herein, the feedback signal apparatus is configured to provide a feedback signal is selected from the group consisting of a visible signal, an audible signal, a tactile signal, and combinations of two or more thereof.

In some embodiments of the systems described herein, the verification unit comprises a microphone and an audio signal processor, wherein the microphone and the audio signal processor are configured to collect sound during delivery of the registered health care bundle and to process the collected sound to determine if the sound comprises the one or more selected audio signatures associated with proper delivery of the registered health care bundle.

In some embodiments of the systems described herein, the central controller comprises a remote audio signal processor configured to process the sound collected by the verification unit to determine if the sound collected by the verification unit comprises the one or more selected audio signatures associated with proper delivery of the registered health care bundle; and the verification unit comprises a microphone, an audio signal processor, and a communication device configured to transmit the sound collected by the verification unit during delivery of the registered health care bundle to the remote audio signal processor.

In some embodiments of the systems described herein, the system further comprises a supplemental audio collection device configured to collect at least a portion of the sound collected during delivery of the registered health care bundle. In some embodiments, the supplemental audio collection device comprises a stethoscope.

In some embodiments, the system is configured to identify a selected non-speech pattern that comprises one or more of: sound produced by running water, sound produced when operating a hand sanitizer dispenser, sound in a frequency range above 20 kiloHertz, and sound produced when opening a selected package.

In some embodiments of the systems described herein, the stored indicator comprises text data.

In some embodiments of the systems described herein, if a selected audio signature in the sound collected during delivery of the registered health care bundle comprises a selected speech pattern, the stored indicator comprises text data derived from the selected speech pattern.

In some embodiments of the systems described herein, if the selected audio signature in the sound collected during delivery of the registered health care bundle comprises a selected non-speech pattern, the stored indicator comprises at least a portion of the sound collected by the verification unit that contains the selected non-speech pattern.

In some embodiments of the systems described herein, if the selected audio signature in the sound collected during delivery of the registered health care bundle comprises a selected non-speech pattern, the stored indicator comprises a representative sound associated with the selected non-speech pattern, wherein the representative sound is not the sound collected during delivery of the registered health care bundle.

In some embodiments of the systems described herein, if the one or more images collected during delivery of the registered health care bundle comprises a selected object, the stored indicator comprises at least a portion of the image that contains the selected object.

In some embodiments of the systems described herein, if the one or more images collected during delivery of the registered health care bundle comprises a selected object, the stored indicator comprises a representative image associated with the selected object, wherein the representative image is not the image collected during delivery of the registered health care bundle.

In some embodiments of the systems described herein, if the one or more selected audio signatures in the sound collected during delivery of the health care bundle comprise two selected audio signatures, the system is configured to: determine if the two selected audio signatures occur in a selected order and/or within a selected period of time that is associated with proper delivery of the registered health care bundle; and provide a delivery feedback signal using the verification unit after determining if the two selected audio signatures occur in the selected order and/or within the selected period of time.

In some embodiments of the systems described herein, if the one or more selected audio signatures in the sound collected during delivery of the health care bundle comprise two selected audio signatures that comprise a selected speech pattern and a selected non-speech pattern, the system is configured to: determine if the selected speech pattern and the selected non-speech pattern occur in a selected order and/or within a selected period of time that is associated with proper delivery of the registered health care bundle; and provide a delivery feedback signal using the verification unit after determining if the selected speech pattern and the selected non-speech pattern occur in the selected order and/or within the selected period of time.

In some embodiments of the systems described herein, if one or more selected audio signatures in the sound collected during delivery of the health care bundle comprises two selected speech patterns, the system is configured to: determine if the two selected speech patterns occur in a selected order and/or within a selected period of time that is associated with proper delivery of the registered health care bundle; and provide a delivery feedback signal using the verification unit after determining if the two selected speech patterns occur in the selected order and/or within the selected period of time.

In some embodiments of the systems described herein, if the one or more selected audio signatures in the sound collected during delivery of the health care bundle comprise two selected speech patterns and a selected non-speech pattern, the system is configured to: determine if the two selected speech patterns and the selected non-speech pattern occur in a selected order and/or within a selected period of time that is associated with proper delivery of the registered health care bundle; and provide a delivery feedback signal using the verification unit after determining if the two selected speech patterns and the selected non-speech pattern occur in the selected order and/or within the selected period of time.

In some embodiments of the systems described herein, the verification unit is configured to collect one or more images associated with delivery of the registered health care bundle; and the system is configured to: determine if the one or more images collected during delivery of the registered health care bundle comprise a selected object that is associated with proper delivery of the registered health care bundle; provide a delivery feedback signal using the verification unit after determining if the one or more images collected during delivery of the registered health care bundle comprises the selected object; and store an indicator that is indicative of at least one selected object associated with proper delivery of the registered health care bundle found in the one or more images collected during delivery of the registered health care bundle.

In some embodiments of the systems in which one or more images are collected, the verification unit comprises a camera and an image processor, wherein the camera and the image processor configured to collect the images and to process the collected images to determine if the one or more images comprise the selected object associated with proper delivery of the registered health care bundle.

In some embodiments of the systems in which one or more images are collected, wherein the central controller comprises a remote image processor configured to process the images collected by the verification unit to determine if the one or more of the images collected by the verification unit comprise the selected object associated with proper delivery of the registered health care bundle; and the verification unit comprises a camera, an image processor, and a communication device configured to transmit images collected by the verification unit during delivery of the registered health care bundle to the remote image processor.

In some embodiments of the systems in which one or more images are collected, the system further comprises a supplemental image collection device configured to collect at least one image of the one or more images collected during delivery of the registered health care bundle. In some embodiments, the supplemental image collection device is selected from a group consisting of an ultrasonic imaging device, an imaging otoscope, a barcode scanner, a cell phone, and combinations thereof.

In some embodiments of the systems described herein, if the delivery data collected during delivery of the registered health care bundle comprises a selected audio signature and a selected object, the system is configured to: determine if the selected audio signature and the image comprising the selected object were collected in a selected order and/or within a selected period of time that is associated with proper delivery of the registered health care bundle; and provide a delivery feedback signal using the verification unit after determining if the selected audio signature and an image comprising the selected object were collected in the selected order and/or within the selected period of time.

In some embodiments of the systems described herein, if the delivery data collected during delivery of the registered health care bundle comprises a selected speech pattern and an image comprising a selected object, the system is configured to: determine if the selected speech pattern and the image comprising the selected object were collected in a selected order and/or within a selected period of time that is associated with proper delivery of the registered health care bundle; and provide a delivery feedback signal using the verification unit after determining if the selected speech pattern and the image comprising the selected object were collected in the selected order and/or within the selected period of time.

In some embodiments of the systems described herein, if the delivery data collected during delivery of the registered health care bundle comprises a selected non-speech pattern and an image comprising a selected object, the system is configured to: determine if the selected non-speech pattern and the image comprising the selected object were collected in a selected order and/or within a selected period of time that is associated with proper delivery of the registered health care bundle; provide a delivery feedback signal using the verification unit after determining if the selected non-speech pattern and the image comprising the selected object were collected in the selected order and/or within the selected period of time.

In some embodiments of the systems described herein, the registration apparatus of the verification unit is configured to collect sound as a part of registering the health care bundle; and the system is configured to determine if the sound collected as a part of registering the health care bundle comprises a selected speech pattern that is associated with identification of the health care bundle.

In some embodiments of the systems described herein, the registration apparatus of the verification unit is configured to obtain bundle data from a bundle credential associated with the selected health care bundle.

In some embodiments of the systems described herein, the registration apparatus of the verification unit is configured to obtain the bundle data associated with the selected health care bundle by scanning optical indicia on the bundle credential associated with the selected health care bundle.

In some embodiments of the systems described herein, the registration apparatus of the verification unit is configured to obtain an image associated with the selected health care bundle; and the system is configured to determine if the image contains a selected object associated with identification of the selected health care bundle.

In some embodiments of the systems described herein, the publication apparatus is configured to publish at least one instruction for delivering the registered health care bundle to the selected patient.

In some embodiments of the systems described herein, the selected information published by the publication apparatus is stored in the verification unit.

In some embodiments of the systems described herein, the selected information published by the publication apparatus is stored in the central controller and wherein the system is configured to deliver the selected information to the verification unit during delivery of the registered health care bundle.

In some embodiments of the systems described herein, if the one or more images collected during delivery of the health care bundle comprise two images, each of which contains a selected object associated with proper delivery of the registered health care bundle, the system is configured to: determine if the two images were collected in a selected order and/or within a selected period of time that is associated with proper delivery of the registered health care bundle; and provide a delivery feedback signal using the verification unit after determining if the two images were collected in the selected order and/or within the selected period of time.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a health care bundle may be used to refer to one, two, three or more health care bundles.

The term “and/or” means one or all of the listed elements or a combination of any two or more of the listed elements.

The above summary is not intended to describe each embodiment or every implementation of the methods, apparatus, and systems for verifying delivery of a health care bundle to a patient as described herein. Rather, a more complete understanding of the methods, apparatus, and systems described herein will become apparent and appreciated by reference to the following Description of Illustrative Embodiments and claims in view of the accompanying figures of the drawing.

### BRIEF DESCRIPTION OF DRAWINGS

FIG. 1 is a schematic diagram of one illustrative embodiment of a method of verifying delivery of a health care bundle as described herein.

FIG. 2 is a schematic diagram of a portion of an illustrative method of providing registration feedback as a part of a method of verifying delivery of a health care bundle as described herein.

FIG. 3 is a schematic diagram of a portion of an illustrative method of determining if sound collected during delivery of a health care bundle includes a selected audio signature associated with proper delivery of the health care bundle.

FIG. 4 is a schematic diagram of a portion of an illustrative method of determining if two selected audio signatures identified in the sound collected during delivery of a health care bundle occur in a selected order that is associated with proper delivery of the health care bundle.

FIG. 5 is a schematic diagram of a method of collecting one or more images during delivery of a health care bundle and using those images to provide delivery feedback signals as described herein.

FIG. 6 is a schematic diagram of a portion of an illustrative method of determining if one or more of the images collected during delivery of a health care bundle includes a selected object associated with proper delivery of the health care bundle.

FIG. 7 is a schematic diagram of a portion of an illustrative method of determining if an audio signature and an image including a selected object were collected in a selected order that is associated with proper delivery of a health care bundle.

FIG. 8 is a schematic diagram of another illustrative embodiment of a method of verifying delivery of a health care bundle as described herein that includes publishing selected information associated with a health care bundle being delivered to a patient.

FIG. 9 is a schematic diagram of another illustrative embodiment of a method of verifying delivery of a health care bundle as described herein that includes the use of images to verify proper delivery of the health care bundle.

FIG. 10 is a schematic diagram of a portion of an illustrative method of determining whether or not the images containing two selected objects were collected in a selected order that is associated with proper delivery of a health care bundle.

FIG. 11 is a schematic diagram of another illustrative embodiment of a method of verifying delivery of a health care bundle as described herein which includes publishing selected information associated with a health care bundle being delivered as well as collecting and processing images.

FIG. 12 is a schematic diagram of one embodiment of a verification unit that may be used in connection with the methods, apparatus, and systems described herein.

FIG. 13 is a perspective view of another illustrative embodiment of a verification unit that may be used with the methods, apparatus, and systems described herein.

FIG. 14 is a schematic diagram of one illustrative system that may be used to verify proper delivery of health care bundles within, e.g., a health care facility.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments in which the systems and/or methods described herein may be practiced. It is to be understood that other embodiments may be utilized and structural changes may be made without departing from the scope of the present invention.

Various illustrative embodiments of methods of verifying delivery of a health care bundle to a patient are depicted in the schematic diagrams provided herein. Generally, the methods, apparatus and systems described herein involve the collection of delivery data in the form of sound and/or images (which can include collections thereof e.g., video) during delivery of a health care bundle to a selected patient. That delivery data is then analyzed to identify selected audio signatures (in the case of sound) and/or selected objects (in the case of images) that are associated with proper delivery of a health care bundle. Various feedback signals can then be provided at the point-of-care, i.e., where the health care bundle is being delivered so that proper delivery of the health care bundle can be either verified or corrected. In addition, the method can include the storing of indicators that are indicative of proper delivery of the health care bundle so that a record can be maintained that the health care bundle was (or was not) properly delivered to the patient.

The various methods, apparatus, and systems described herein may be configured to verify proper delivery of health care bundles within any selected health care facility. As used herein, the term “health care facility” may include a variety of environments including, for example, hospitals, long-term care facilities, hospice facilities, health clinics, home health care environments, or any other patient occupied setting.

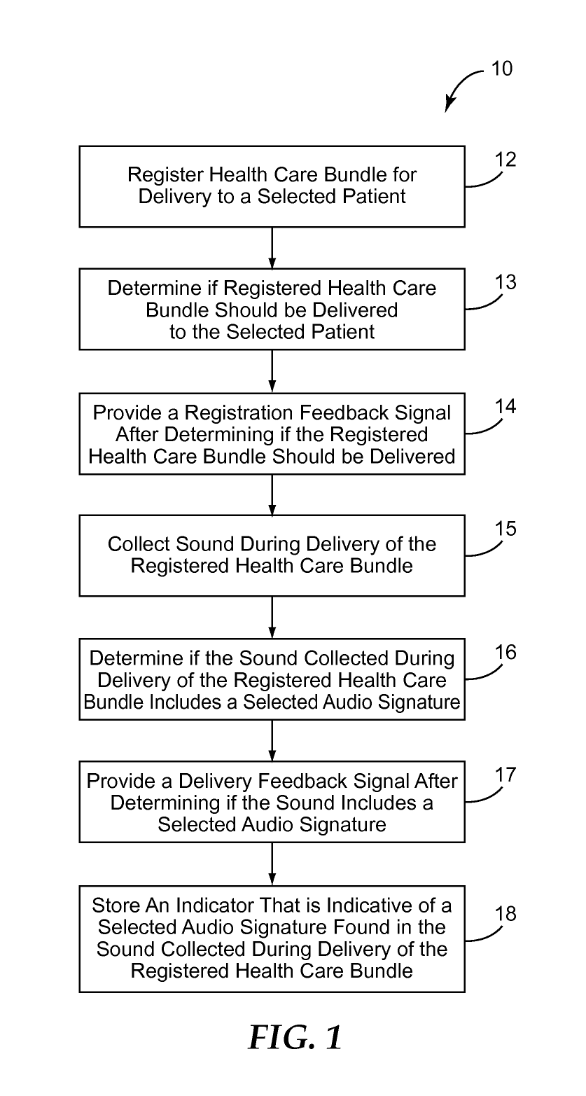

Referring to FIG. 1, in one illustrative embodiment the method 10 may involve registering a health care bundle to be delivered to a selected patient (12). The registration process used to register the health care bundle for delivery to a selected patient may take a wide variety of forms. The registration process will, however, typically involve making or creating an association between the health care bundle and the patient to which it is to be delivered. That association can, for example, involve scanning a barcode or detecting other optical indicia, using a proximity based detection system (e.g., a Radio Frequency Identification system (RFID), etc.), entering alphanumeric data using a keyboard, etc.

In connection with the methods, apparatus and systems described herein, the registration process may involve detecting or collecting data in the form of one or more selected audio signatures (e.g., spoken words or sounds) and/or one or more selected objects found in one or more images in addition to or in place of the registration methods described in the preceding paragraph. If the registration process involves the detection of selected audio signatures in the form of spoken words, the method may further involve processing sound containing spoken words using voice-recognition software to detect one or more selected speech patterns (i.e., where each selected speech pattern comprises one or more spoken words, acronyms, etc.) that can be used to identify the health care bundle to be delivered to the selected patient. If the registration process involves collecting one or more images, the images may be processed to identify any selected objects in the images that are associated with identification of the health care bundle to be delivered to the selected patient.

In some embodiments of the methods of registering a health care bundle for delivery to a selected patient, the registration process may involve obtaining bundle data from a bundle credential associated with the selected health care bundle. In such methods, each of the health care bundles preferably includes a bundle credential associated with the health care bundle. In many instances, a health care bundle may include one or more items which may be disposable or reusable. In such situations, the bundle credential may be provided on or in the item itself and/or in packaging used to deliver the one or more items of the health care bundle.

Each of the bundle credentials may include bundle data that is associated with the selected health care bundle that is associated with the bundle credential. In some embodiments, the bundle data may be limited, e.g., to identification of the selected health care bundle. In other embodiments, the bundle data present on or in a bundle credential may include information such as, e.g., one or more instructions for use or delivery of the health care bundle, the delivery protocols associated with delivery of the health care bundle, etc. The bundle credentials may take a variety of different forms, e.g., a batch, tag, label, or any other article that can be carried by or otherwise attached to one or more items that are included in the health care bundle. Regardless of the physical form of the bundle credentials, they preferably include bundle data in one or more forms, with the bundle data being used to register the health care bundle associated with the bundle credential to a selected patient as described herein.

Potential forms of the bundle data may be, e.g., optical indicia, volatile/nonvolatile memory (e.g., flash memory, etc.), alphanumeric characters, etc. the form or forms in which the bundle data is stored are preferably compatible with any registration apparatus used to obtain the bundle data from the bundle credentials as a part of the registration process. Depending on the form in which the bundle data is provided, the registration process may include the use of components configured to obtain the bundle data through one, two, or more different modes, e.g., wirelessly (using RF, ultrasonics, etc.), optically, using a keyboard, using a mouse, using a touchscreen, using a touchpad, using a camera, using a microphone, etc.

Once the health care bundle has been registered (12), the method may further include determining if the registered health care bundle should be delivered to the selected patient (13). That determination may be made based on orders or other information associated with the selected patient. In other words, has this patient been identified as needing the registered health care bundle and/or is it appropriate to deliver the registered health care bundle to the selected patient. As described herein, such determinations may be made on a local level using, e.g., a verification unit as described herein, or in a larger system, the determination may be made at a more central location, e.g., using a controller that manages health care bundle delivery to multiple patients in multiple locations.

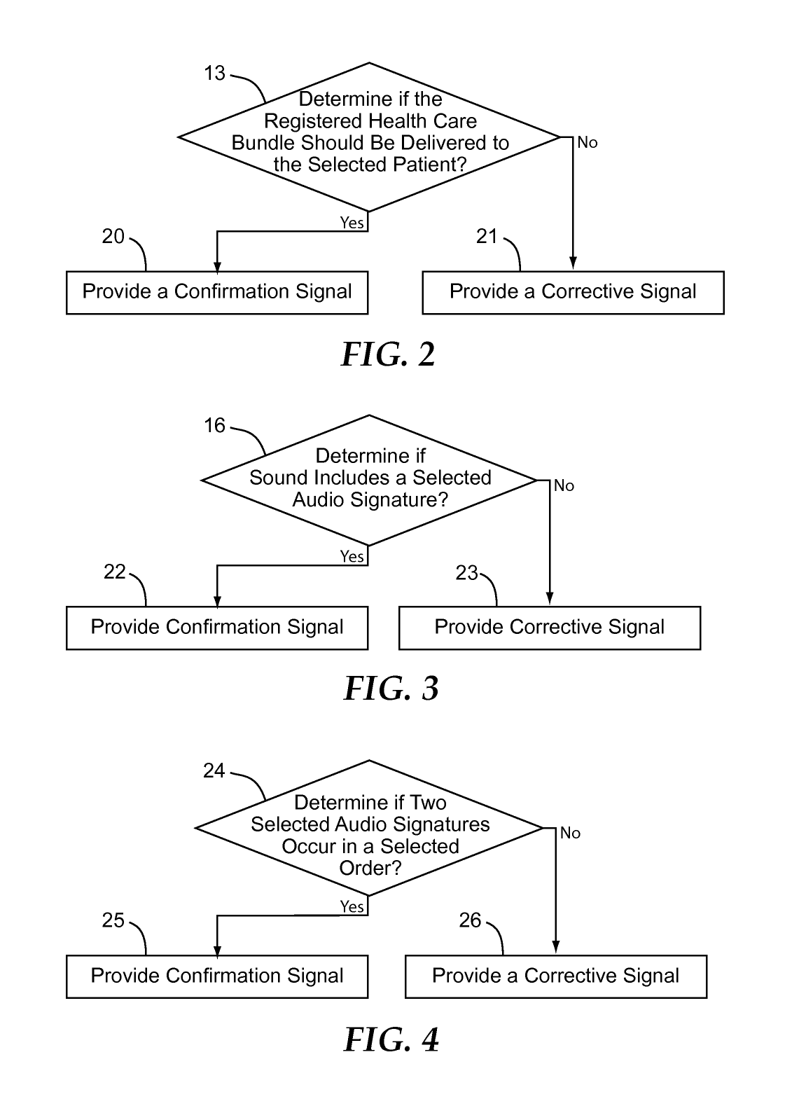

After the determination has been made as to whether or not the registered health care bundle should be delivered to the selected patient (13), the method may further include providing a registration feedback signal using the verification unit (14) after determining if the registered health care bundle should be delivered to the selected patient. Referring to FIG. 2, the registration feedback may take the form of at least one of, e.g., a confirmation signal (20) if the registered health care bundle should be delivered to the selected patient, and a corrective signal (21) if the registered health care bundle should not be delivered to the selected patient.

By describing that the method involves providing at least one of the confirmation signal (20) and the corrective signal (21), it should be understood that in some embodiments, the method may involve providing only one of the feedback signals. For example, the method may provide only a confirmation signal (20) when it is determined that the registered health care bundle should be delivered to the selected patient, while no registration feedback signal would be delivered if it is determined that the registered health care bundle should not be delivered to the selected patient. In other embodiments, the method may provide only a corrective signal (21) when it is determined that the registered health care bundle should not be delivered to the selected patient, while no registration feedback signal would be delivered if it is determined that the registered health care bundle should be delivered to the selected patient.

The feedback signals (regardless of whether they are registration or delivery feedback signals) provided in the methods of delivering health care bundles as described herein may take many different forms. For example, the feedback signals may be provided in a visible, audible, tactile, or any other format capable of being sensed by a person. In some methods, the feedback signals may be provided in more than one format, e.g., both a visible and audible signal may be provided to better ensure notification. The feedback signals may be delivered from a verification unit as described herein or by any other apparatus designed to provide a feedback signal that can be sensed by a person delivering a health care bundle for which verification is being performed. In the case of a visible feedback signal, the feedback signal may be in the form of one or more lights, screen images on computerized devices, etc. In the case of and audible feedback signal the feedback signal may be in the form of one or more tones, beeps, chimes, voices, etc. In the case of a tactile feedback signal, the tactile signal may be in the form of a vibration, temperature change, etc.

The feedback signals may, in some instances, be described as alerts that may be provided using any suitable component(s) of the systems present at the point of delivery of the health care bundle. Examples of some components that may be used to deliver feedback signals (e.g., alerts) may be found in, e.g., US Patent Application Publication US 2008/0246599 (Hufton et al.); U.S. Pat. No. 6,975,231 (Lane et al.); U.S. Pat. No. 6,882,278 (Winings et al.); U.S. Pat. No. 6,727,818 (Wildman et al.); U.S. Pat. No. 6,426,701 (Levy et al.); U.S. Pat. No. 5,952,924 (Evans et al.); U.S. Pat. No. 5,202,666 (Knippscheer); U.S. Pat. No. 4,896,144 (Bogstad); etc.

In some embodiments, the feedback signals delivered in response to improper health care bundle delivery may be tiered. In other words, the registration feedback may be issued to the health care worker delivering the health care bundle such that the health care worker may take corrective actions at the point-of-care. As another tier, feedback signals may be delivered, in some instances, to supervisory personnel (e.g., to the nursing station, etc.). As yet another tier, feedback signals may be delivered to health care facility quality assurance and/or management personnel. The higher tier alerts may be based on accumulated compliance data, i.e., if the compliance percentages for proper delivery of one or more health care bundles in a section of the health care facility begin to fall, the alert to supervisory, management, and/or quality personnel can provide an opportunity for corrective action on a broader basis.

In addition, the feedback signals can be dynamic, i.e., if compliance with proper health care bundle delivery protocols for a selected health care worker, group of health care workers, etc. begins to decline, some embodiments of the methods, apparatus, and systems described herein may provide a different set of feedback signals that may, for example, be more urgent, noticeable, etc. Such dynamic feedback signals may also be configured for delivery to a wider group, e.g., supervisory, quality, and/or management personnel within the health care facility.

Referring again to FIG. 1, the methods of delivering a registered health care bundle to a selected patient may also include collecting delivery data during delivery of the registered health care bundle to the selected patient (15). In some embodiments, the delivery data that is collected is in the form of sounds associated with delivery of the registered health care bundle. The sound delivery data collected during delivery of registered health care bundle may be in the form of words spoken by health care provider delivering the health care bundle and/or they may be in the form of non-speech sounds associated with delivery of the registered health care bundle.

In those methods in which sounds are collected during delivery of the registered health care bundle, the collected sounds may be processed to determine if the sound collected during delivery of the registered health care bundle includes one or more selected audio signatures that are associated with proper delivery of the registered health care bundle (16). The selected audio signatures associated with proper delivery of the health care bundle may be in the form of, e.g., a selected speech pattern spoken during delivery of the registered health care bundle and/or a selected non-speech pattern collected during delivery of the registered health care bundle.

If the sounds collected during delivery of the registered health care bundle are in the form of spoken words, those words may be spoken by the person delivering the health care bundle to be indicative of the actions taken during delivery of the registered health care bundle. Those words may include, for example, the names of items associated with the health care bundle and/or words that describe the actions taken during delivery of the health care bundle. Processing of the sound data collected the form of spoken words may involve determining whether or not the words are in the form of a selected speech pattern that is associated with proper delivery of the registered health care bundle where the selected speech pattern is an audio signature that is associated with proper delivery of the registered health care bundle.

If the sounds collected during delivery of the registered health care bundle are in the form of non-speech sounds associated with delivery of the health care bundle, those sounds may include, for example, the sound of a dispenser dispensing hand sanitizing solution, the sound of water running in a faucet, the sound of an individual washing his or her hands, the sound of a package being opened, the sound of a bed or other equipment being adjusted, etc. In such situations, processing of the sound data collected during delivery of the health care bundle may involve determining whether or not the sounds collected are in the form of a selected non-speech pattern that is associated with proper delivery of the registered health care bundle where the selected non-speech pattern is an audio signature associated with proper delivery of the health care bundle.

Referring to FIG. 3, the methods of verifying proper delivery of a registered health care bundle as described herein may include providing a delivery feedback signal after determining whether or not the sound collected during delivery of a health care bundle includes the one or more selected audio signatures (16) associated with proper delivery of the health care bundle. The delivery feedback signals may include at least one of a corrective signal (23) if the sound does not include at least one selected audio signature associated with proper delivery of the registered health care bundle and/or a confirmation signal (22) if the sound includes at least one selected audio signature associated with proper delivery of the registered health care bundle.

Although some methods of delivering health care bundles as described herein may include providing delivery feedback signals in the form of both a corrective signal (23) and a confirmation signal (22) depending on the determination of the presence or absence of a selected audio signature associated with proper delivery of the health care bundle, in other embodiments, the methods may involve delivery of only one of the delivery feedback signals.

For example, the method may provide only a confirmation signal (22) when it is determined that the sound collected during delivery of the registered health care bundle includes one or more of the selected audio signatures associated with proper delivery of the health care bundle, while no delivery feedback signal would be delivered if it is determined that the sounds collected during delivery of the registered health care bundle do not include one or more of the selected audio signatures associated with proper delivery of the registered health care bundle. In other embodiments, the method may provide only a corrective signal (23) when it is determined that the sounds collected during delivery of the registered health care bundle do not include one or more of the selected audio signatures associated with proper delivery of the health care bundle, while no delivery feedback signal would be provided if it is determined that the sounds collected during delivery of the registered health care bundle include one or more of the selected audio signatures associated with proper delivery of the registered health care bundle.

In those methods in which both a confirmation signal (22) and a corrective signal (23) are delivered as a part of the method of verifying delivery of a health care bundle, the form in which the two different delivery feedback signals are delivered may be the same or different. For example, a confirmation signal (22) may be provided in the form of a light or other less prominent form, while a corrective signal (23) may be provided in a form that is more prominent, e.g., one or more of a buzzer, vibration, light, etc. may be used for a corrective signal to indicate that one or more of the selected audio signatures associated with proper delivery of the health care bundle were not detected as a part of the sounds collected during delivery of the registered health care bundle.

The methods of verifying proper delivery of a registered health care bundle to a selected patient as described herein may also include, in some embodiments, storing an indicator that is indicative of at least one of the selected audio signatures found in the sound collected during delivery of the registered health care bundle (18). The indicator stored may be in the form of data and may be stored in a device that is local, i.e., in proximity to the location at which the health care bundle is being delivered (e.g., in a verification unit or other device as described herein) or, it may be stored in a remote location, e.g., in a central controller that includes memory for storing such indicators.

In some methods as described herein, the indicator stored may be generally indicative of proper delivery of the registered health care bundle as a whole, as opposed to a method in which the stored indicator is associated with or indicative of selected portions of delivery of a registered health care bundle, e.g., a specific action or use of a specific component of a registered health care bundle. In those methods in which stored indicators are associated with or indicative of selected portions of delivery of a health care bundle, the method may involve storing all of the indicators associated with all of the selected portions of delivery of the health care bundle. In other embodiments, the method may involve storing only some of the indicators that are associated with some of the selected portions of delivery of a health care bundle. For example, if the registered health care bundle being delivered includes handwashing as a part of the proper delivery process, the method may involve storing only an indicator that soap was dispensed or that water was turned on as an indication that the handwashing occurred as a part of delivery of the health care bundle.

In some embodiments of the methods of verifying proper delivery of a registered health care bundle as described herein, the stored indicators may be in the form of text data that is indicative of proper delivery of the registered health care bundle or a portion of proper delivery of a registered health care bundle. In some methods, the stored text data may be transcribed speech spoken by a health care worker delivering the health care bundle. In other methods, the stored text data may be text data that is assigned to a specific task associated with the health care bundle delivery process. For example, the text data may be in the form of “washed hands” if the selected audio signature is associated with the washing of hands as part of the health care bundle delivery process. In such a process, the text data stored as a part of delivery of the registered health care bundle may be described as being derived from the selected speech pattern identified in the sound collected during delivery of the registered health care bundle.

In those embodiments in which the selected audio signature is in the form of sound collected during delivery of the registered health care bundle where that sound does not include speech, the method may involve identification of a selected non-speech pattern in the collected sound and the stored indicator may include at least a portion of the actual sound collected during delivery of the registered health care bundle. For example, if the delivery process includes sanitizing hands using a hand sanitizer dispenser, and the sound of that dispenser being actuated is associated with proper delivery of the health care bundle, the stored indicator may include an actual audio clip obtained during actuation of the dispenser by the health care worker as a part of the delivery process. Other examples of audio clips that may be associated with selected non-speech patterns identified as being associated with proper delivery of the health care bundle may include, e.g., sound associated with the opening of the package, sound associated with the adjustment of equipment (adjusting a bed, etc.).

If the selected audio signature in the sound collected during delivery of the registered health care bundle includes a selected non-speech pattern, the stored indicator may be in the form of a representative sound clip associated with the selected non-speech pattern identified in the sound collected during delivery of the health care bundle. For example, the representative sound may be selected from a pre-existing bank of sound clips that may be similar to the actual sound detected as part of the health care bundle delivery process, but the representative sound is not the actual sound collected during delivery of the health care bundle.

In those embodiments in which sound is used to verify proper delivery of a registered health care bundle, the method may be performed using a verification unit (embodiments of which are described herein) that includes a microphone or other audio collection device and an audio signal processor for processing the sound detected by the microphone. The microphone and the audio signal processor are, in some embodiments, configured to collect sound during delivery of the registered health care bundle and to process the collected sound to determine if the sound includes one or more of the selected audio signatures that are associated with proper delivery of the registered health care bundle. Methods in which the verification unit is used to both collect sound during delivery of a health care bundle and to process that sound to determine if the sound contains one or more of the selected audio signatures may be described as methods in which “local” processing of the sound is performed.

In other embodiments of the methods described herein, a verification unit including both a microphone and an audio signal processor may be used to collect the sound generated during delivery of a health care bundle. However, the microphone and an audio signal processor of the verification unit may be configured to transmit the sound collected during delivery of the health care bundle to a remote audio signal processor. The remote audio signal processor may be configured to process the sound collected by the verification unit to determine if the sound includes one or more of the selected audio signatures associated with proper delivery of a health care bundle. Methods in which the verification unit is used only to collect sound while a remote audio signal processor is used to process the sound to determine if the sound contains one or more of the selected audio signatures may be described as methods in which “remote” processing of the sound is performed.

In some embodiments of the methods described herein, a supplemental audio collection device may be used in connection with or in place of a verification unit to collect sound generated during delivery of a registered health care bundle. Such a supplemental audio collection device may communicate directly with a verification unit (as described herein below) or the supplemental audio device may communicate with other devices in a network to provide the sound collected during delivery of the registered health care bundle for processing by an audio signal processor included in the system practicing the method described herein. Examples of some potential supplemental audio collection devices may include, e.g., stethoscopes, cell phones, and other recording devices, etc.

Some embodiments of the methods described herein in which selected audio signatures are collected during delivery of a health care bundle may include determining whether or not the selected audio signatures occur in one or more selected orders that are associated with proper delivery of a registered health care bundle. In other words, delivery of a health care bundle will typically involve a specific sequence of steps which should be performed in a particular order so that proper delivery of the health care bundle occurs. If the selected audio signatures are collected during delivery of a health care bundle in an order that is not one of the selected orders associated with proper delivery, then the feedback should not be provided to a user that would be associated with proper delivery of the health care bundle.

Referring to FIG. 4, in some embodiments where, for example, one or more selected audio signatures in the sound collected during delivery of the health care bundle include two selected audio signatures, the method may include determining if the two selected audio signatures found in the collected sound occur in a selected order that is associated with proper delivery of a registered health care bundle (24). After a determination has been made as to whether or not selected audio signatures occur in the selected order, a delivery feedback signal may be provided to the person delivering the health care bundle. That delivery feedback signal may be provided using, e.g., the verification unit or any other apparatus capable of providing a feedback signal that can be detected by the person delivering the health care bundle.

In other embodiments of the methods described herein, a determination may be made as to whether or not two or more selected audio signatures are collected within a selected period of time (in addition to or in place of a selected order). In such an embodiment, if the two or more selected audio signatures occur within a selected period of time (e.g., 5 seconds, 10 seconds, etc.), a determination could be made that the proper health care bundle delivery protocol was followed because the selected audio signatures were identified in collected sound within the selected period of time. Accordingly, a confirmation signal could be delivered to the health care worker or other person as an indication that the proper health care bundle delivery protocol was followed. Conversely, if the selected audio signatures did not occur within the selected period of time (e.g., 5 seconds, 10 seconds, etc.), a determination could be made that the proper health care bundle delivery protocol was not followed. Accordingly, a corrective signal could be delivered to the health care worker or other person as an indication that the proper health care bundle delivery protocol was not followed.

The delivery feedback signals provided in the methods described herein may include a confirmation signal (25) if, e.g., the two selected audio signatures occur in the selected order and/or within a selected period of time that is associated with proper delivery of the registered health care bundle. The confirmation signal may preferably confirm to the person delivering the health care bundle that the proper order of steps has been performed in the delivery process. The delivery feedback signals provided in the methods described herein may also include a corrective signal (26) if the two selected audio signatures detected in the sound collected during delivery of the health care bundle do not occur in the selected order and/or within the selected period of time that would be associated with proper delivery of the registered health care bundle. The corrective signal may preferably provide an indication to the person delivering the health care bundle has not been properly delivered and may, in some embodiments, provide them with the ability to rectify any errors made in delivery of the health care bundle before continuing with subsequent steps.

Although some methods of delivering health care bundles as described herein may include providing delivery feedback signals in the form of both a confirmation signal (25) and a corrective signal (26) depending on the determination regarding proper delivery of a health care bundle, some methods of verifying proper delivery of health care bundles as described herein may involve delivery of only one of the delivery feedback signals.

For example, in some embodiments, the method may provide only a confirmation signal (25) when it is determined that the health care bundle has been properly delivered, while no delivery feedback signal would be provided if it is determined that the health care bundle has not been properly delivered. In other embodiments the method may provide only a corrective signal (26) when it is determined that the health care bundle has not been properly delivered (thus providing the person performing the delivery within indication that an error has been made), while no delivery feedback signal would be provided if it is determined that the health care bundle has been properly delivered.

In those methods in which both a confirmation signal (25) and a corrective signal (26) are provided as a part of the method, the form of the delivery feedback signals may be the same or different. For example, a confirmation signal (25) may be provided in the form of a light or other relatively less prominent form, while a corrective signal (26) may be provided in a form that is more prominent, e.g., one or more of a buzzer, vibration, light, etc. may be used to indicate that the health care bundle was not properly delivered.

Where determinations are made as to whether or not two or more selected audio signatures occur in one or more selected orders and/or within a selected period of time, the two or more selected audio signatures may include any variety of combinations of selected audio signatures. For example, the selected audio signatures may be in the form of two or more selected speech patterns that are associated with proper delivery of a health care bundle, two or more selected non-speech patterns that are associated with proper delivery of a health care bundle, and any combination of one or more selected speech patterns and one or more selected non-speech patterns, etc.

For example, if a selected speech pattern and a selected non-speech pattern identified in the sound collected during delivery of a health care bundle are in the form of, e.g., a statement by a person delivering the health care bundle that they are “washing hands” and the selected non-speech pattern is in the form of sounds associated with water running from a faucet, it may be preferred that the selected order of those two audio signatures require that the statement “washing hands” occur before the sound associated with water running from a faucet is collected. If the selected non-speech pattern and the selected speech pattern do not occur in the selected order, and a corrective signal (26) may be provided. Alternatively, if the selected non-speech pattern and the selected speech pattern do occur in the selected order, a confirmation signal (25) may be provided. As discussed herein, in some embodiments, both a confirmation signal (25) and a corrective signal (26) may be provided, while in other embodiments only one or the other of the confirmation signal (25) and the corrective signal (26) may be provided.

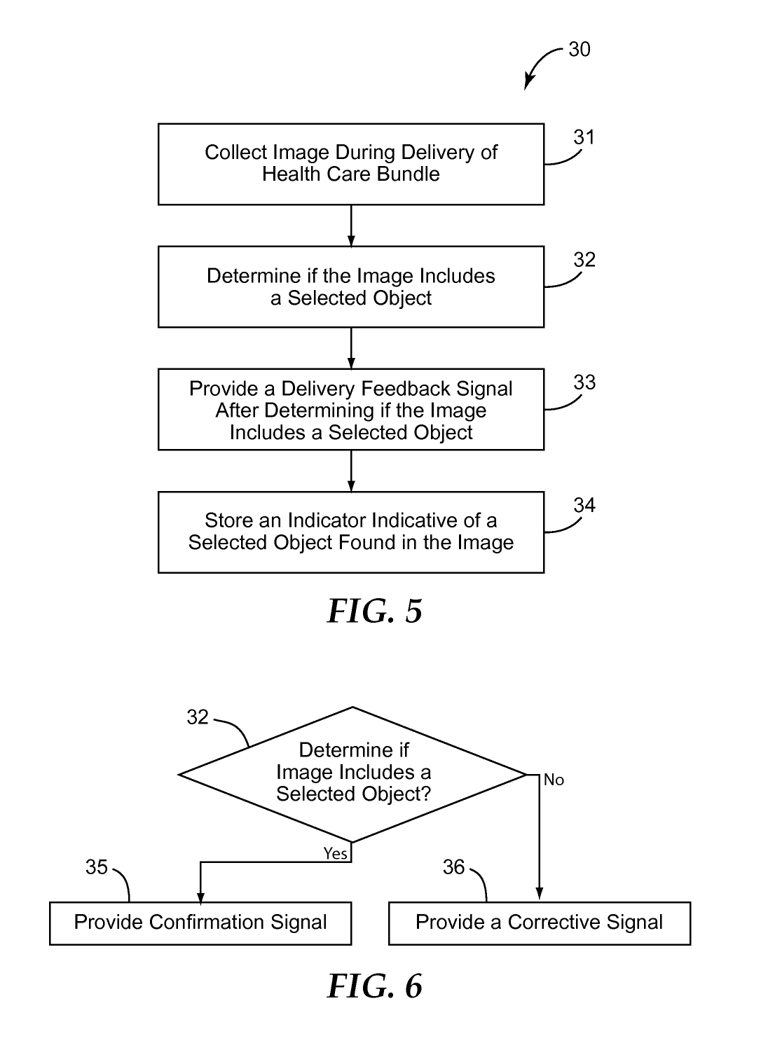

Referring to FIG. 5, some methods of verifying proper delivery of a registered health care bundle may involve the collection of one or more images during delivery of the health care bundle (31). The one or more images may be provided as discreet images or can be provided compiled in real-time or near real-time as a video. In embodiments of the methods including collection of video, the images may be or may not be coupled with audio. Collection of the images may be described as collecting delivery data during delivery of the registered health care bundle to the selected patient. A determination may be made based on the one or more images collected during delivery of the registered health care bundle to determine whether or not the one or more images include one or more selected objects that are associated with proper delivery of the registered health care bundle (32). For example, an object in an image collected during delivery of the health care bundle may be in the form of the shape of one or more components of a kit used as a part of the health care bundle. An image acquired of that component would be expected to contain an object that could be identified in the collected image and then associated with that component.

Some embodiments of the methods in which images and selected objects in those images are used to verify delivery of a health care bundle may include providing a delivery feedback signal after determining if the images contain one or more of the selected objects associated with proper delivery of the health care bundle (33). Further still, some embodiments of methods of verifying proper delivery of a health care bundle to a selected patient may include storing an indicator that is indicative of one or more of any selected objects found in the one or more images collected during delivery of the health care bundle (34).

In some embodiments of the methods described herein, the indicator stored may be generally indicative of proper delivery of the registered health care bundle as a whole, as opposed to methods in which the stored indicator or indicators are associated with or indicative of selected portions of delivery of the health care bundle, e.g., a specific action or use of a specific component of a health care bundle. In those methods in which stored indicators are associated with or indicative of selected portions of delivery of a health care bundle, the method may involve storing all of the indicators associated with all of the selected portions of delivery of the health care bundle. In other embodiments, the method may involve storing only some of the indicators that are associated with some of the selected portions of delivery of the health care bundle. For example, if the registered health care bundle being delivered includes handwashing as a part of the proper delivery process, the method may involve storing only an indicator that the health care worker or other person being monitored was positioned by a dispenser of hand sanitizing solution as could be determined by identifying an object associated with such a dispenser in one or more of the images collected during delivery of the health care bundle.

In some embodiments of methods of verifying proper delivery of a registered health care bundle as described herein, the stored indicator may be in the form of text data that is indicative of proper delivery of the registered health care bundle or a portion of proper delivery of registered health care bundle. In methods in which images are used as part of the verification process the stored text data may be based on identification of one or more of the selected objects in the images collected during delivery of the health care bundle. For example, if a selected object is associated with a dispenser of hand sanitizing solution, the text data may be in the form of “sanitized hands” when that selected object is found in the one or more images collected during delivery of the health care bundle.

In those methods in which identification of selected objects in the images collected during delivery of a health care bundle are used to verify proper delivery of that health care bundle, the stored indicator may be in the form of the actual image or at least a portion of the actual image that contains the selected object identified in the images collected. In other embodiments, the stored indicator may be in the form of a representative object or image that is selected based on identification of the selected object in the one or more actual images collected during delivery of the health care bundle.

Referring to FIG. 6, methods of verifying proper delivery of a registered health care bundle as described herein may include providing a delivery feedback signal after determining if one or more of the images collected includes one or more of the selected objects (32) associated with proper delivery of a health care bundle. The delivery feedback signals may include a confirmation signal (35) if the images do include at least one of the selected objects associated with proper delivery of the health care bundle and/or a corrective signal (36) if the images do not include at least one of the selected objects associated with proper delivery of the health care bundle.

In the same manner as described above in connection with those methods in which sound and selected audio signatures are used to verify proper delivery of a health care bundle, methods which use images and selected objects in those images to verify proper delivery of a health care bundle may involve delivery of one or both of the confirmation signal (35) and the corrective signal (36). For example, the method may include providing only a confirmation signal (35) when it is determined that the images collected during delivery of a health care bundle include one or more of the selected objects, while no delivery feedback signal would be delivered if it is determined that the images collected during delivery of the health care bundle do not include one or more of the selected objects associated with proper delivery of the health care bundle. In other embodiments, the method may provide only a corrective signal (36) when it is determined that the images collected during delivery of the health care bundle do not include one or more of the selected objects, while no delivery feedback signal would be provided if it is determined that the images collected during delivery of the health care bundle do include one or more of the selected objects associated with proper delivery of the health care bundle.

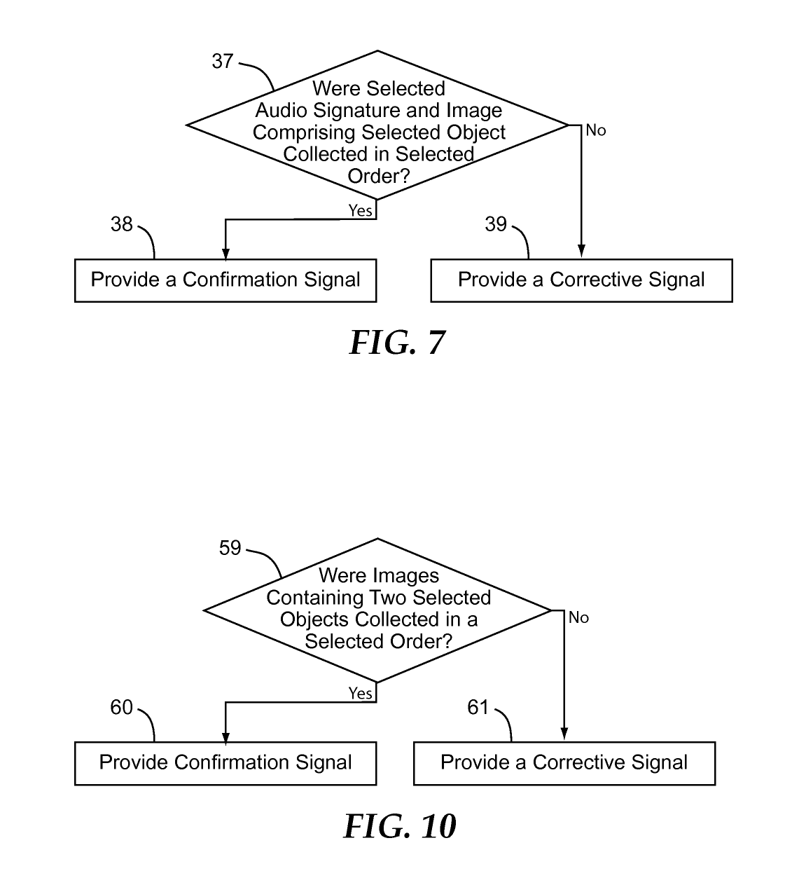

Referring to FIG. 7, in some embodiments of the methods described herein in which both selected audio signatures and selected objects found in images collected during delivery of a health care bundle are used to verify proper delivery of the health care bundle, a determination may be made as to whether a selected audio signature and an image containing a selected object were collected in a selected order that is associated with proper delivery of a health care bundle (37). The selected audio signature may be in the form of a selected speech pattern or a selected non-speech pattern. Still other embodiments may include making determinations regarding proper delivery of health care bundles based on whether or not the selected audio signature and selected object were obtained within a selected period of time.

In those instances in which a selected audio signature and an image containing a selected object were collected in the selected order that is associated with proper delivery, a confirmation signal may be provided to indicate that the selected order was followed (38). In those instances in which a selected audio signature and an image containing a selected object were not collected in the selected order that is associated with proper delivery, a corrective signal may be provided to indicate that the selected order was not followed (39).

For example, in a handwashing scenario, a selected audio signature may be in the form of a selected speech pattern, e.g., the spoken words “washed hands,” while the selected object identified in an image collected during delivery of the health care bundle may be in the form of a soap dispenser, sink, hand sanitizer dispenser, etc. In such a situation, if the selected object (e.g., a soap dispenser) was found in an image (including video) collected before the selected speech pattern (e.g., the spoken words “washed hands”), a determination could be made that the selected order associated with proper handwashing protocols was not followed because the spoken words indicated that the person had washed his or her hands before they were present at a soap dispenser. Accordingly, a corrective signal (39) could be delivered to the health care worker or other person as an indication that the proper handwashing protocol was not followed.

In another example of a handwashing scenario, a selected audio signature identified in sound collected during delivery of a health care bundle may be in the form of a selected speech pattern, e.g., the spoken words “washed hands,” while no selected object in the form of a soap dispenser, sink, hand sanitizer dispenser, etc. was identified in any image collected during delivery of the health care bundle may be. In such a situation, a determination could be made that the proper handwashing protocol was not followed because the spoken words indicated that the person had washed his or her hands, but the images collected do not include any selected object that would correspond to the selected audio signature. Accordingly, a corrective signal (39) could be delivered to the health care worker or other person as an indication that the proper handwashing protocol was not followed.

In another example of a handwashing scenario, a selected audio signature identified in sound collected during delivery of a health care bundle may be in the form of a selected speech pattern, e.g., the spoken words “washed hands,” while the selected object identified in an image collected during delivery of the health care bundle may be in the form of a soap dispenser, sink, hand sanitizer dispenser, etc. In such a situation, if the selected object (i.e., the soap dispenser) was found in an image collected outside of a selected period of time (e.g., 5 seconds, 10 seconds, etc.) before and/or after the selected speech pattern (i.e., the spoken words “washed hands”), a determination could be made that the selected order associated with proper handwashing protocols was not followed because the spoken words and the selected object were collected over an excessive period of time. Accordingly, a corrective signal (39) could be delivered to the health care worker or other person as an indication that the proper handwashing protocol was not followed. Conversely, if the selected object (e.g., a soap dispenser) was found in an image collected within a selected period of time (e.g., 5 seconds, 10 seconds, etc.) before and/or after the selected speech pattern (i.e., the spoken words “washed hands”), a determination could be made that the selected order associated with proper handwashing protocols was followed because the spoken words and the selected object were collected within the selected period of time. Accordingly, a confirmation signal (38) could be delivered to the health care worker or other person as an indication that the proper handwashing protocol was not followed.

In another example of a handwashing scenario, a selected audio signature may be in the form of a selected non-speech pattern, e.g., the sound of water running in a sink. The selected object identified in an image collected during delivery of the health care bundle may be in the form of, e.g., a soap dispenser. In such a situation, if the selected object (i.e., the soap dispenser) was found in an image collected before the selected non-speech pattern (i.e., the sound of running water), a determination could be made that the selected order associated with proper handwashing protocol was followed because the image containing a selected object in the form of a soap dispenser was collected before the water was running in the sink. Accordingly, a confirmation signal (38) could be delivered to the health care worker or other person as an indication that the proper handwashing protocol was followed.

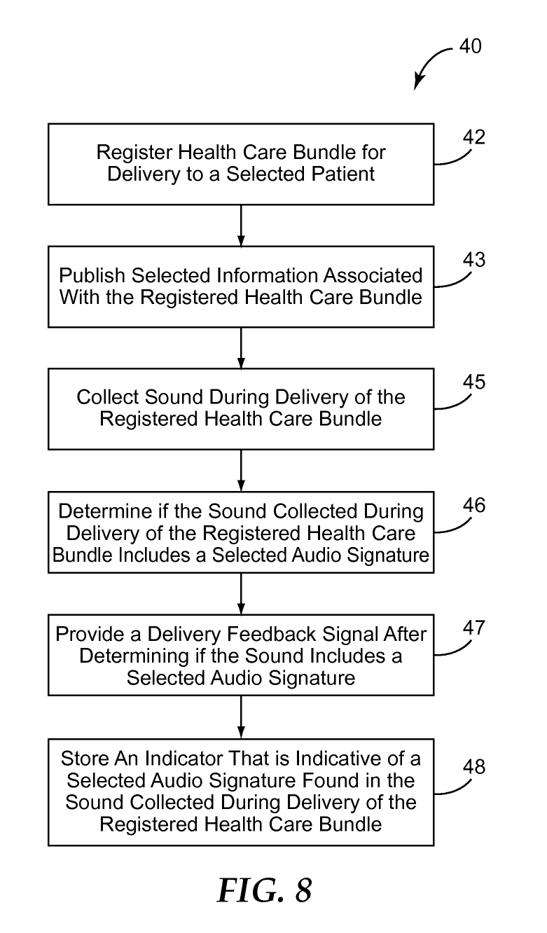

Referring to FIG. 8, an alternative illustrative embodiment of another method of verifying proper delivery of a health care bundle to a selected patient is depicted. The method depicted in connection with FIG. 8 includes a number of the same steps as described above in connection with the method depicted in FIG. 1. Among the steps shared in the two different methods depicted in FIGS. 1 and 8 are registration of a health care bundle for delivery to a selected patient (42), collecting sound during delivery of the registered health care bundle (45), determining if the sound collected during delivery of the registered health care bundle includes a selected audio signature that is associated with proper delivery of the health care bundle (46), providing a delivery feedback signal after determining whether or not the sound includes one or more of the selected audio signatures that would be associated with proper delivery of the health care bundle (47), and storing an indicator that is indicative of one or more of the selected audio signatures found in the sound collected during delivery of the health care bundle (48).

The method of verifying proper delivery of a registered health care bundle as depicted in connection with FIG. 8, includes publishing selected information that is associated with the health care bundle being delivered to the patient. The publishing may take a variety of different forms, for example, the publishing may include visual and/or audible communication of the selected information such that a person located in or near the publication apparatus can perceive the published information. In many cases, that person would be a health care worker who is there to deliver the health care bundle to the patient. The information published as part of the publication process may preferably include at least one instruction for delivering the registered health care bundle to the selected patient. For example, the publication may provide instructions on the proper order in which particular steps may be performed, e.g., that a package should be opened before a health care worker's hands are sanitized, that a patient's bed should be raised or lowered as a part of the health care bundle delivery process, etc.

The selected information that is delivered as a part of the publication process may be provided in a verification unit that is used as part of the process of verifying proper delivery of a health care bundle or, in other methods, the selected information may be delivered to the verification unit after a health care bundle has been registered for delivery to a selected patient. In such a process, the selected information may be stored in a central location from which it is transmitted to the verification unit after or during registration of the health care bundle.

In some embodiments, the selected information that is published may be obtained from a bundle credential that forms a part of the health care bundle itself. In other embodiments, the selected information that is published may be obtained from memory resident on or in a verification unit. In still other embodiments, the selected information that is published may be obtained from a central location as described above, with the selected information being transmitted to, e.g., a verification unit as a part of, e.g., a registration process for the health care bundle.

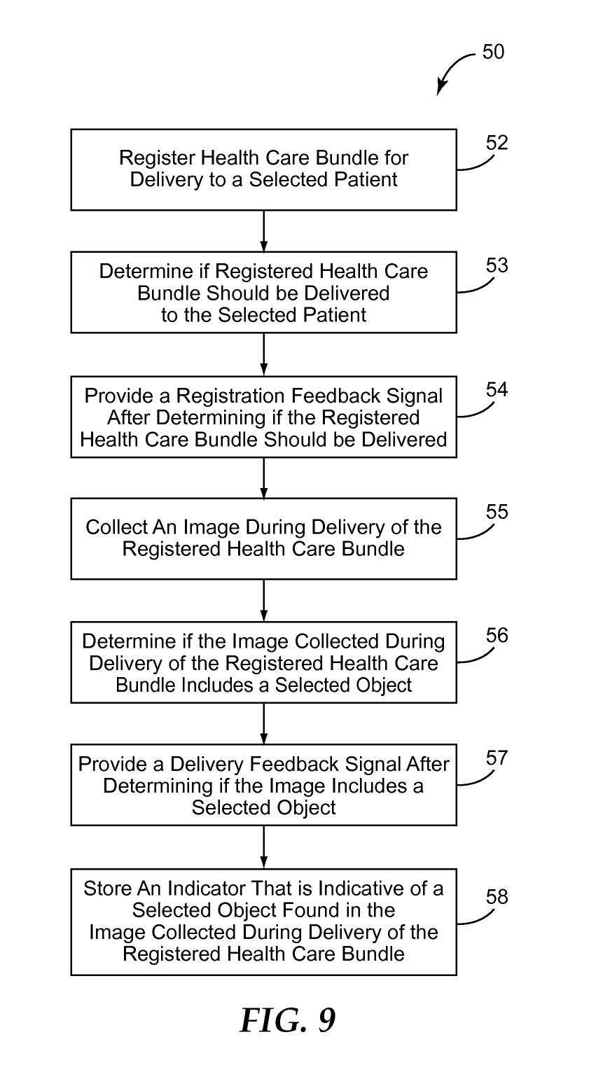

Referring to FIG. 9, another alternative illustrative embodiment of another method of verifying proper delivery of the health care bundle to a selected patient is depicted. The method depicted in connection with FIG. 9 includes a number of the same steps as described above in connection with the method depicted in FIG. 1. Among the steps shared in the two different methods depicted in FIGS. 1 and 9 are registration of a health care bundle for delivery to a selected patient (52), determining if a registered health care bundle should be delivered to the selected patient (53), and providing registration feedback signals after determining whether or not the registered health care bundle should be delivered to the selected patient (54).

While the method depicted in FIG. 1 focuses on the use of the sound and a selected audio signatures to verify proper delivery of a health care bundle, the method depicted in FIG. 9 relies on the collection and processing of images to determine whether or not those images contain selected objects that are associated with proper delivery of a health care bundle. As a result, the method depicted in FIG. 9 involves the collection of one or more images (e.g, as a video compilation thereof) during delivery of the registered health care bundle (55). The method depicted in FIG. 9 also includes determining if the images collected during delivery of the registered health care bundle include selected objects that are associated with proper delivery of the bundle (56), providing one or more delivery feedback signals after determining whether or not the images collected during delivery of the registered health care bundle include one or more of the selected objects that are associated with proper delivery (57), and storing one or more indicators that are indicative of the one or more selected objects found in the images collected during delivery of the registered health care bundle (58). In many respects, the image collection processing and delivery feedback signals, as well as storing of indicators, are all described above in connection with the image collection and processing depicted in FIG. 5.

In those embodiments in which images and selected objects in the images are used to verify proper delivery of a health care bundle, the method may be performed using a verification unit (illustrative embodiments of which are described herein) that includes a camera (which can be e.g., a digital, film, or video camera) and an image processor for processing the images collected using the camera. The camera and the image processor may preferably be configured to collect images during delivery of the health care bundle and to process the images to determine if the images include one or more of the selected objects that are associated with proper delivery of the health care bundle. Methods in which the verification unit itself is used to both collect images during delivery of a health care bundle and to process those images to determine if they contain one or more of the selected objects may be described as methods in which “local” processing of the images is performed.

In other embodiments of the methods described herein, a verification unit including both a camera and an image processor may be used to collect images during delivery of a health care bundle. However, the camera and image processor of the verification unit may be configured to transmit the images collected during delivery of the health care bundle to a remote image processor. The remote image processor may be configured to process the images collected by the verification unit to determine if the images include one or more of the selected objects associated with proper delivery of a health care bundle. Methods in which the verification unit is used only to collect images, while a remote image processor is used to process the images to determine if those images include one or more of the selected objects may be described as methods in which “remote” processing of the images is performed.

In some embodiments of the methods described herein, a supplemental image collection device may be used with or in place of a verification unit to collect images during delivery of a health care bundle. Such a supplemental image collection device may communicate directly with a verification unit (as described herein) or the supplemental image collection device may communicate with other devices in a network to provide images collected by the supplemental image collection device during delivery of the health care bundle for processing by an image processor included in the system used to practice the methods described herein. Examples of some potential supplemental image collection devices may include, e.g., ultrasonic imaging devices, imaging otoscopes, barcode scanners, cell phones, and other image collection devices, etc.

Referring to FIG. 10, the methods of verifying proper delivery of a registered health care bundle as described herein may include determining whether or not the images containing the selected objects were collected in one or more selected orders that are associated with proper delivery of a registered health care bundle. In other words, delivery of a health care bundle typically involves a specific sequence of steps which should be performed in one or more particular orders so that proper delivery of the health care bundle occurs. If the images containing the selected objects are collected in an order that is not one of the selected orders associated with proper delivery, then the system should not provide a user with feedback that would be associated with proper delivery of the health care bundle and/or feedback that would alert the user to a failure to deliver the health care bundle in the proper order.

FIG. 10 depicts one illustrative method in which two images collected during delivery of a health care bundle contain selected objects associated with proper delivery of the registered health care bundle. The method further includes determining if the two images were collected in a selected order that is associated with proper delivery of the health care bundle (59). After a determination has been made as to whether or not the images were collected in the selected order, a delivery feedback signal may be provided to the person delivering the health care bundle. That delivery feedback signal may be provided using, e.g., a verification unit or any other apparatus capable of delivering feedback signals that can be detected by the person delivering the health care bundle.

The delivery feedback signals provided in the methods described in connection with FIG. 10 include a confirmation signal (60) if the two images containing the selected objects were collected in a selected order that is associated with proper delivery of the registered health care bundle. As described herein, the confirmation signal will confirm to the person delivering the health care bundle that the proper order of steps has been performed in the delivery process based on the determination that the images containing the selected objects were collected in the selected order. The delivery feedback signals provided in the method described in connection with FIG. 10 may also include a corrective signal (61) if the two images containing the selected objects were not collected in a selected order that is associated with proper delivery of the registered health care bundle. The corrective signal will preferably provide an indication to the person delivering the health care bundle that the proper order of steps has not been performed in the delivery process and may, in some embodiments, provide them with the ability to rectify any errors made in delivery of the health care bundle before continuing with subsequent steps.

In other embodiments of the methods described herein, a determination may be made as to whether or not two or more selected objects are found in images that are collected within a selected period of time (in addition to or in place of a selected order). In such an embodiment, if the two or more selected objects are found in images that are collected within a selected period of time (e.g., 5 seconds, 10 seconds, etc.), a determination could be made that the proper health care bundle delivery protocol was followed because the selected objects were identified in images obtained within the selected period of time. Accordingly, a confirmation signal could be delivered to the health care worker or other person as an indication that the proper health care bundle delivery protocol was followed. Conversely, if the selected objects were not found in images that were obtained within the selected period of time (e.g., 5 seconds, 10 seconds, etc.), a determination could be made that the proper health care bundle delivery protocol was not followed. Accordingly, a corrective signal could be delivered to the health care worker or other person as an indication that the proper health care bundle delivery protocol was not followed.

Although some methods of verifying proper delivery of health care bundles as described herein may include providing delivery feedback signals in the form of both a confirmation signal (60) and a corrective signal (61) depending on the determination made regarding proper order in the delivery process, some methods of verifying proper delivery of health care bundles as described herein may involve delivery of only one of the delivery feedback signals. In other words, depending on the determination made as to whether or not the images were collected in the selected order and/or within a selected period of time, one or both of the confirmation signal (60) and the corrective signal (61) may be provided as a part of some embodiments of the methods described herein.

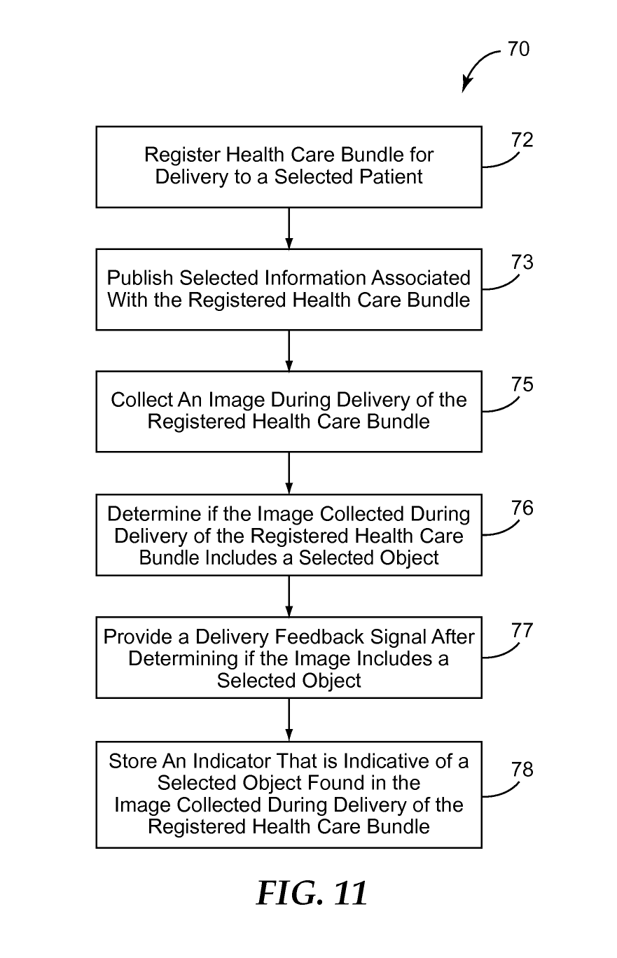

Referring to FIG. 11, another alternative illustrative embodiment of another method of verifying proper delivery of a health care bundle is depicted. The method depicted in connection with FIG. 11 includes a number of the same steps as described above in connection with the methods depicted in FIG. 9. Among the steps shared in the different methods depicted in FIGS. 9 and 11 are registration of a health care bundle for delivery to a selected patient (72), collecting one or more images during delivery of the registered health care bundle (75), determining if the images collected during delivery of the registered health care bundle include one or more selected objects associated with proper delivery of the health care bundle (76), providing delivery feedback signals after determining if the images include one or more selected objects in that are associated with proper delivery (77), and storing an indicator that is indicative of a selected object found in the images collected during delivery of the health care bundle (78).

While the method of verifying proper delivery of a health care bundle as depicted in FIG. 9 includes steps that involve determining whether or not the registered health care bundle should be delivered to the selected patient, the method depicted in FIG. 11 includes publishing selected information associated with the registered health care bundle as described in connection with the method of FIG. 8.

The various embodiments of methods as depicted in FIGS. 1, 8, 9, and 11 are described as including either a registration process in which a determination is made that a registered health care bundle should be delivered to a selected patient (see FIGS. 1 and 9) or a publication process in which selected information associated with the registered health care bundle is published to deliver that information to a health care worker (see FIGS. 8 and 11). It should be understood that in some embodiments of the methods described herein of verifying proper delivery of a health care bundle may include both of these features, i.e., determining that the registered health care bundle should be delivered to a selected patient as described in connection with FIGS. 1 and 9, as well as publishing selected information associated with the registered health care bundle as described in connection with FIGS. 8 and 11. Furthermore, it should also be understood that some methods of verifying proper delivery of a health care bundle may include neither of those processes, i.e., the methods may not involve determining that a registered health care bundle should be delivered to a selected patient or publication of any selected information associated with the registered health care bundle. In other words, those portions of the methods described herein should be considered optional.

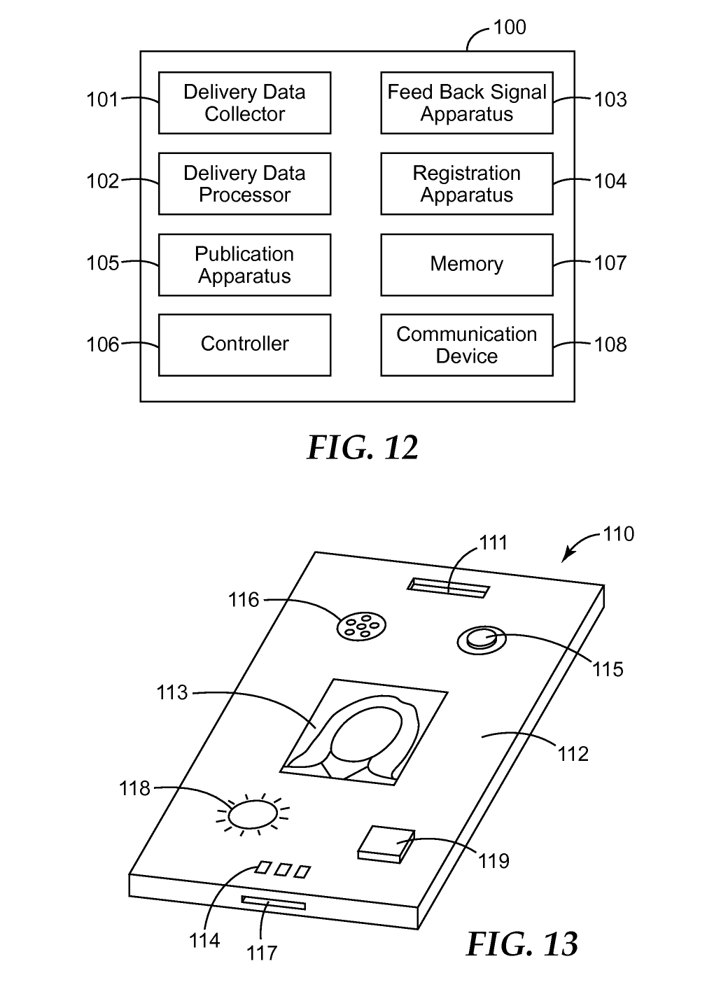

As discussed herein, the various methods of verifying proper delivery of a health care bundle to a patient may be performed using a verification unit. The verification units used in connection with the methods described herein may include a variety of different components. One illustrative embodiment of a verification unit is depicted schematically in FIG. 12.

As depicted in FIG. 12, the verification unit 100 may include a delivery data collector 101, a delivery data processor 102, a feedback signal apparatus 103, a registration apparatus 104, and a publication apparatus 105. Also depicted in the diagram of FIG. 12 are a controller 106, memory 107, and a communication device 108.

The verification unit 100 may be provided in a variety of different forms. For example, in some embodiments the verification unit 100 may be embodied in a device that also serves as a badge for a health care worker or other person. As used herein, the term “health care worker” may refer to people who are professional caregivers (e.g., nurses, nursing assistants, physicians, physician assistants, etc.). Other individuals may also be associated with a badge if, for example, they are involved in the delivery of health care bundles as discussed herein (e.g., relatives, friends, etc.). Those individuals may take the status of the health care worker in, e.g., a home health care setting, hospice facility, etc. in which they may be delivering the health care bundles.

In addition to or in place of badges, the verification units 100 may be provided in a number of different formats that are capable of providing the functions of a verification unit as described herein. For example, the verification unit may be provided in the form of a device that can be carried by or is otherwise attached to a selected person (e.g., a patient or health care worker) or a piece of equipment in or on which the patient is located (e.g., a wheelchair, bed, etc.). For example, the verification unit 100 may be provided in a format similar to a cell phone, personal digital assistant (PDA), tablet computer, etc. In some embodiments the verification units 100 may be stationary devices positioned at fixed locations in a health care facility such that the verification units do not move with patients. In still other embodiments of systems and methods described herein, some of the verification units may be mobile devices, while others may be stationary.

In a verification unit 100, the delivery data collector 101 and the delivery data processor 102 may be configured to collect one or both of sounds or images and to process the sounds or images to identify selected audio signatures for selected objects as described herein. For example, if the delivery data collector 101 is configured to collect sounds during delivery of a health care bundle, the delivery data collector may be in the form of a microphone or other audio collection device. If the delivery data collector 101 is configured to collect images during delivery of a health care bundle, the delivery data collector may be in the form of a camera or other image collection device.

In those embodiments in which remote processing of the sounds or images are to be performed, the communication device 108 may be used to transmit the sounds or images to a remote delivery data processor that is configured to process the sounds and/or images as described herein. The communication device 108 is preferably capable of transmitting and/or receiving data using any communication protocol suitable for practicing the methods described herein. For example, the communication device may be in the form of a wireless communication device or, in other embodiments, the communication device may be in the form of a device that requires a wired connection to transmit and/or receive data.

The feedback signal apparatus 103 provided as part of a verification unit 100 may be configured to deliver the feedback signals described herein in connection with the methods of verifying proper delivery of a health care bundle in any suitable form, e.g., visible, audible, tactile, etc. Example of some alerts and equipment used to deliver those alerts may be found in, e.g., US Patent Application Publication US 2008/0246599 (Hufton et al.); U.S. Pat. No. 6,975,231 (Lane et al.); U.S. Pat. No. 6,882,278 (Winings et al.); U.S. Pat. No. 6,727,818 (Wildman et al.); U.S. Pat. No. 6,426,701 (Levy et al.); U.S. Pat. No. 5,952,924 (Evans et al.); U.S. Pat. No. 5,202,666 (Knippscheer); U.S. Pat. No. 4,896,144 (Bogstad); etc. In still other embodiments, the feedback signals may be provided using devices are apparatus that are not part of a verification unit as described herein.

The registration apparatus 104 provided as part of a verification unit 100 may be configured to register a health care bundle for delivery to a selected patient as described herein. That registration process and the registration apparatus 104 configured to perform the process may involve any combination of components configured to obtain information that can identify a health care bundle to be delivered to a selected patient. For example, the registration apparatus 104 may be configured to obtain identification information associated with a health care bundle through one, two, or more different modes, e.g., wirelessly (using RF, ultrasonics, etc.), optically (using a camera or other optical data acquisition device), through data entry (using, e.g., a keyboard, mouse, touch screen, touchpad, etc.), through the use of sound as described herein (using, e.g., a microphone or other audio collection device), and/or through images as described herein.

The publication apparatus 105 that may be provided in connection with a verification unit 100 may take a variety of different forms that are preferably capable of publishing information that can be perceived by a person. Examples of some potentially suitable devices that may be used as a part of a publication apparatus 105 may include a visual display device and/or an audio device. Examples of some potentially suitable visual display device is may include, but are not limited to, liquid crystal displays and other machines adapted to display analog and/or digital images, printers, backlit displays designed for use with printed checklists, etc. an audio device (e.g., a speaker, etc.) used in connection with the publication apparatus 105 may be used to provide the selected information in and audible format.

The verification units 100 may, in some embodiments, include a controller 106 that may be configured to control one or more of the other components found in the verification unit 100. The controller 106 may include any suitable processor, e.g., an application specific integrated circuit (ASIC) state machine, a gate array, a microprocessor, a microcontroller, etc.

The verification unit 100 may also include memory 107 that can be used to store data that is either collected by the verification unit 100 order that is used as a part of operation of the verification unit 100. For example, the memory 107 may be used to store the indicators that are associated with selected audio signatures and/or selected objects in images collected using the verification unit as described herein. The memory 107 may also be used to store identification information related to registration of a health care bundle to be delivered to a selected patient in some embodiments of the verification units described herein. Furthermore, the memory 107 may be used to store selected information that is delivered using the publication apparatus 105 as described herein embodiments of data that may be stored in the memory 107 are described herein, should be understood that other data may be stored in the memory as well. The controller 106, memory 107 and communication device 108 may be used to transmit and/or receive information for the verification unit 100 as described herein.

One embodiment of a verification unit 110 is depicted in FIG. 13. The depicted embodiment of verification unit 110 is in the form of a badge 112 that may be worn by a health care worker or other person. The badge 112 includes an opening 111 that may be used to attach verification unit 110 to a person using a clip, lanyard, etc. the badge 112 may also include a photograph or other identification information 113 used to identify the person carrying the badge 112.

In addition to performing the functions associated with a badge, the verification unit 110 also includes components used to perform the methods described herein. For example, the badge 112 includes a microphone 114 used to collect sounds during delivery of a health care bundle. The badge 112 also includes a speaker 116 that may be used to deliver feedback signals as described herein and/or selected information associated with delivery of the health care bundle as part of a publication process. The badge 112 also includes a light 118 that can be used to deliver feedback signals as described herein, as well as a camera 115 that may be used to obtain images during delivery of a registered health care bundle and/or images that may be used as part of a registration process as described herein. The badge 112 also may include a port 117 that can be used to connect the components within the badge to an external device for the transfer of data to the badge 112 or from the badge 112.

The badge 112 also includes an optional actuator 119 that may be used to actuate one or more functions of the components associated with the badge. For example, the actuator 119 may be used to e.g. begin a sound recording process, obtain an image, indicate initiation and/or completion of delivery of a registered health care bundle, or any other function for which a discrete actuation event may be desired. Although depicted in the form of a button, the actuator 119 may be provided in any suitable form, e.g. high capacitive touch sensor, resistive touch sensor, etc.

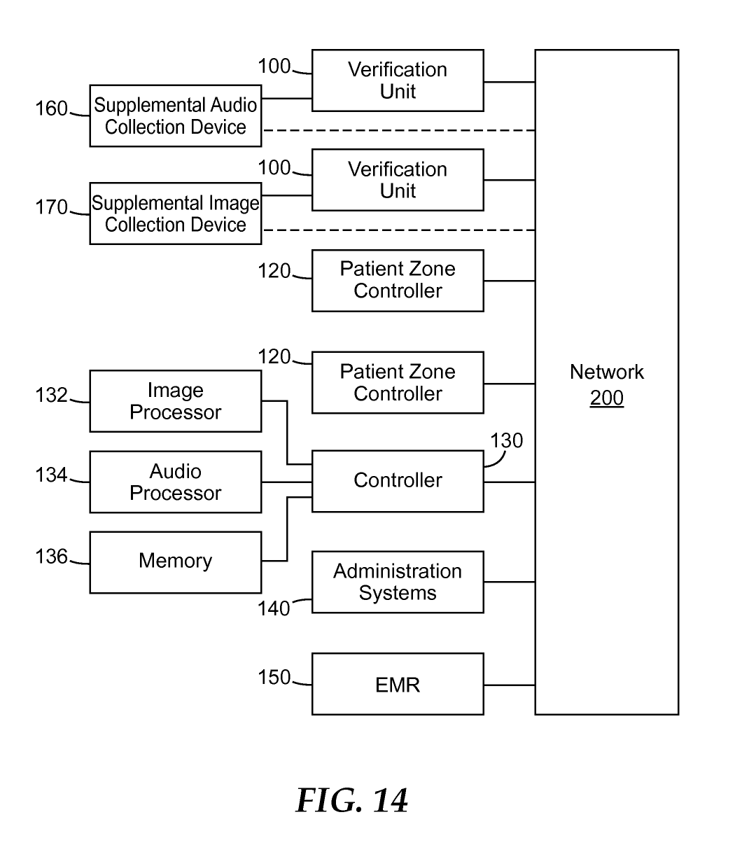

In some embodiments, the verification units used to verify proper delivery of a health care bundle may be used alone, i.e., not in connection with a larger system or other verification units. In many instances however, the verification units may be used as part of a larger system within, e.g., a health care facility to verify proper delivery of registered health care bundles as described herein. One illustrative embodiment of a larger system in which verification units 100 may be used to verify proper delivery of a registered health care bundle is depicted in FIG. 14.

As depicted in FIG. 14, the larger system may include multiple verification units 100, patient zone controllers 120, one or more controllers 130, one or more administrative systems 140, and one or more electronic medical record (EMR) systems 150. The system also includes a supplemental audio collection device 160 as well as a supplemental image collection device 170. Although a specific number of the different components are depicted in connection with the system of FIG. 14, it should be understood that the systems described herein may include any suitable number of the various components. For example, although the system depicted in FIG. 14 includes two verification units, a system as described herein may be implemented with as few as one verification unit or any other number of verification units.

Similarly, the patient zone controllers 120 are optional, i.e., some systems may include patient zone controllers as described in, e.g., U.S. patent application Ser. No. 12/889,503, titled HYGIENE MONITORING SYSTEMS AND METHODS, filed on Sep. 24, 2010 (Attorney Docket No. 65722US006) and U.S. patent application Ser. No. 12/905,214, titled HEALTH CARE DELIVERY MONITORING SYSTEMS AND METHODS, filed on Oct. 15, 2010 (Attorney Docket No. 65845US005), while other systems may include only one patient zone controller or more than two patient zone controllers.

The various components in the system depicted in FIG. 14 may preferably be operably connected to each other through a network 200 that communicates with the various components through any suitable communication protocol used in similar systems. Examples of some potentially suitable networks and devices that communicate with them may be described in, e.g., U.S. Pat. Nos. 7,639,943; 6,847,334; 5,553,609; 6,122,526; etc.; as well as US Patent Application Publication No. US 2002/0108118 A1.

The optional central controller 130 that may be provided as a part of the system depicted in FIG. 14 may include, e.g., one or more data processing units and software operating to store and or retrieve data that may be used during the methods described herein. As depicted in FIG. 14, the central controller 130 may include an image processor 132, an audio processor 134, and memory 136. The image processor 132 may be used to remotely process images obtained during delivery of a health care bundle as described herein to determine whether or not the images contain selected objects associated with proper delivery of the health care bundle. Similarly, the audio processor 134 that is operably connected to central controller 130 in FIG. 14 may be used to remotely process sounds obtained during delivery of a health care bundle to determine whether the sound contains one or more selected audio signatures that are associated with proper delivery of a health care bundle as described herein.

The memory 136 depicted in FIG. 14 may be used to store the indicators associated with proper delivery of a health care bundle as described herein or for a variety of other purposes. For example, the memory 136 may be used to store selected information associated with delivery of the health care bundles with that selected information being communicated to an individual delivering a health care bundle through the publication process as described herein.

The system depicted in FIG. 14 also includes an administrative system 140 that may be used to monitor the delivery of health care bundles for use in connection with, e.g., inventory management, billing, etc. For example, the administrative system 140 may receive data indicating that a health care bundle has been delivered to a selected patient and that data may be used for billing purposes as well as, e.g., for inventory management within the health care facility.

Yet another optional component provided as a part of the system depicted in FIG. 14 is the connection of an electronic medical record system (EMR) to the system, with the delivery of health care bundles being entered into the electronic medical record system 150 as a part of the health care bundle delivery process.

The supplemental audio collection device 160 and the supplemental image collection device 170 may be provided in the system depicted in FIG. 14 to assist with collection of sounds during delivery of a health care bundle and/or images collected during delivery of a health care bundle. As described herein, the supplemental audio collection device 160 may be in the form of, e.g., a stethoscope or other audio collection device, and it may be directly connected to a verification unit 100 as indicated by the solid line connecting the supplemental audio collection device 160 to the verification unit 100. Alternatively, or in addition to the connection to the verification unit 100, the supplemental audio collection device 160 may be connected to other components of the system through the network 200 as denoted by the broken line connecting the supplemental audio collection device 160 to the network 200.

Similarly, the supplemental image collection device 170 may be in the form of, e.g., an ultrasonic imaging machine or other image collection device, and it may be directly connected to a verification unit 100 as indicated by the solid line connecting the supplemental image collection device 170 to the verification unit 100. Alternatively, or in addition to the connection to the verification unit, the supplemental image collection device 170 may be connected to other components of the system through the network 200 as denoted by the broken line connecting the supplemental image collection device 170 to the network 200.

In those systems in which a supplemental audio collection device 160 and/or a supplemental image collection device 170 are included, the sounds and/or images collected using the supplemental devices may be processed using the central controller 130 where the central controller 130 includes a suitable image processor 132 or audio processor 134 as depicted in the system of FIG. 14.

### EMBODIMENTS

1. A method of verifying delivery of a health care bundle to a patient, the method comprising:

registering a health care bundle to be delivered to a selected patient using a verification unit;

determining if the registered health care bundle should be delivered to the selected patient;

providing a registration feedback signal using the verification unit after determining if the registered health care bundle should be delivered to the selected patient, wherein the registration feedback signal comprises at least one of:
a confirmation signal if the registered health care bundle should be delivered to the selected patient, and
a corrective signal if the registered health care bundle should not be delivered to the selected patient;

collecting delivery data during delivery of the registered health care bundle to the selected patient, wherein the delivery data comprises sound associated with delivery of the registered health care bundle;

determining if the sound collected during delivery of the registered health care bundle comprises one or more selected audio signatures that are associated with proper delivery of the registered health care bundle, wherein each selected audio signature comprises either a selected speech pattern spoken during delivery of the registered health care bundle or a selected non-speech pattern collected during delivery of the registered health care bundle;

providing a delivery feedback signal using the verification unit after determining if the sound comprises the one or more selected audio signatures, wherein the feedback signal comprises at least one of: a corrective signal if the sound does not include at least one selected audio signature associated with proper delivery of the registered health care bundle, and a confirmation signal if the sound includes at least one selected audio signature associated with proper delivery of the registered health care bundle; and storing an indicator that is indicative of at least one of the selected audio signatures found in the sound collected during delivery of the registered health care bundle.

2. A method of verifying delivery of a health care bundle to a patient, the method comprising:

registering a health care bundle to be delivered to a selected patient;

publishing selected information associated with the registered health care bundle using a verification unit;

collecting delivery data during delivery of the registered health care bundle to the selected patient, wherein the delivery data comprises sound associated with delivery of the registered health care bundle;

determining if the sound collected during delivery of the registered health care bundle comprises one or more selected audio signatures that are associated with proper delivery of the registered health care bundle, wherein each selected audio signature comprises either a selected speech pattern spoken during delivery of the registered health care bundle or a selected non-speech pattern collected during delivery of the registered health care bundle;

providing a delivery feedback signal using the verification unit after determining if the sound comprises the one or more selected audio signatures, wherein the feedback signal comprises at least one of: a corrective signal if the sound does not include at least one selected audio signature associated with proper delivery of the registered health care bundle, and a confirmation signal if the sound includes at least one selected audio signature associated with proper delivery of the registered health care bundle; and storing an indicator that is indicative of at least one of the selected audio signatures found in the sound collected during delivery of the registered health care bundle.

3. A method according to either of embodiment 1 or 2, wherein the verification unit comprises a microphone and an audio signal processor, wherein the microphone and the audio signal processor are configured to collect sound during delivery of the registered health care bundle and to process the collected sound to determine if the sound comprises the one or more selected audio signatures associated with proper delivery of the registered health care bundle.
4. A method according to either of embodiment 1 or 2, wherein the verification unit comprises a microphone and an audio signal processor, wherein the microphone and the audio signal processor are configured to transmit the sound collected during delivery of the registered health care bundle to a remote audio signal processor, wherein the remote audio signal processor is configured to process the sound collected by the verification unit to determine if the sound comprises the one or more selected audio signatures associated with proper delivery of the registered health care bundle.
5. A method according to either of embodiment 1 or 2, wherein a supplemental audio collection device collects at least a portion of the sound collected during delivery of the registered health care bundle.
6. A method according to embodiment 5, wherein the supplemental audio collection device comprises a stethoscope.
7. A method according to either of embodiment 1 or 2, wherein a selected non-speech pattern identified in the sound collected during delivery of the registered health care bundle comprises one or more of: sound produced by running water, sound produced when operating a hand sanitizer dispenser, sound in a frequency range above 20 kiloHertz, and sound produced when opening a selected package.
8. A method according to either of embodiment 1 or 2, wherein the stored indicator comprises text data.
9. A method according to either of embodiment 1 or 2, wherein, if a selected audio signature in the sound collected during delivery of the registered health care bundle comprises a selected speech pattern, the stored indicator comprises text data derived from the selected speech pattern.
10. A method according to either of embodiment 1 or 2, wherein, if the selected audio signature in the sound collected during delivery of the registered health care bundle comprises a selected non-speech pattern, the stored indicator comprises at least a portion of the sound collected by the verification unit that contains the selected non-speech pattern.
11. A method according to either of embodiment 1 or 2, wherein, if the selected audio signature in the sound collected during delivery of the registered health care bundle comprises a selected non-speech pattern, the stored indicator comprises a representative sound associated with the selected non-speech pattern, wherein the representative sound is not the sound collected during delivery of the registered health care bundle.
12. A method according to either of embodiment 1 or 2, wherein, if the one or more selected audio signatures in the sound collected during delivery of the health care bundle comprise two selected audio signatures, the method further comprises:

determining if the two selected audio signatures occur in a selected order and/or within a selected period of time that is associated with proper delivery of the registered health care bundle;

providing a delivery feedback signal using the verification unit after determining if the two selected audio signatures occur in the selected order and/or within the selected period of time, wherein the delivery feedback signal comprises at least one of:
a confirmation signal if the two selected audio signatures occur in the selected order and/or within the selected period of time that is associated with proper delivery of the registered health care bundle; and
a corrective signal if the two selected audio signatures do not occur in the selected order and/or within the selected period of time that is associated with proper delivery of the registered health care bundle.
   13. A method according to either of embodiment 1 or 2, wherein, if the one or more selected audio signatures in the sound collected during delivery of the health care bundle comprise two selected audio signatures that comprise a selected speech pattern and a selected non-speech pattern, the method further comprises:

determining if the selected speech pattern and the selected non-speech pattern occur in a selected order and/or within a selected period of time that is associated with proper delivery of the registered health care bundle;

providing a delivery feedback signal using the verification unit after determining if the selected speech pattern and the selected non-speech pattern occur in the selected order and/or within the selected period of time, wherein the delivery feedback signal comprises at least one of: a confirmation signal if the selected speech pattern and the selected non-speech pattern occur in the selected order and/or within the selected period of time that is associated with proper delivery of the registered health care bundle, and a corrective signal if the selected speech pattern and the selected non-speech pattern do not occur in the selected order and/or within the selected period of time that is associated with proper delivery of the registered health care bundle.

14. A method according to either of embodiment 1 or 2, wherein, if one or more selected audio signatures in the sound collected during delivery of the health care bundle comprises two selected speech patterns, the method further comprises:

determining if the two selected speech patterns occur in a selected order and/or within a selected period of time that is associated with proper delivery of the registered health care bundle;

providing a delivery feedback signal using the verification unit after determining if the two selected speech patterns occur in the selected order and/or within the selected period of time, wherein the delivery feedback signal comprises at least one of: a confirmation signal if the two selected speech patterns are in the selected order and/or within the selected period of time that is associated with proper delivery of the registered health care bundle, and a corrective signal if the two selected speech patterns do not occur in the selected order and/or within the selected period of time that is associated with proper delivery of the registered health care bundle.

15. A method according to either of embodiment 1 or 2, wherein, if the one or more selected audio signatures in the sound collected during delivery of the health care bundle comprise two selected speech patterns and a selected non-speech pattern, the method further comprises:

determining if the two selected speech patterns and the selected non-speech pattern occur in a selected order that is associated with proper delivery of the registered health care bundle;

providing a delivery feedback signal using the verification unit after determining if the two selected speech patterns and the selected non-speech pattern occur in the selected order, wherein the delivery feedback signal comprises at least one of: a confirmation signal if the two selected speech patterns and the selected non-speech pattern are in the selected order that is associated with proper delivery of the registered health care bundle, and a corrective signal if the two selected speech patterns and the selected non-speech pattern do not occur in the selected order that is associated with proper delivery of the registered health care bundle.

16. A method according to either of embodiment 1 or 2, wherein collecting delivery data during delivery of the registered health care bundle to the selected patient comprises:

collecting one or more images associated with delivery of the registered health care bundle;

determining if the one or more images collected during delivery of the registered health care bundle comprise a selected object that is associated with proper delivery of the registered health care bundle;

providing a delivery feedback signal using the verification unit after determining if the one or more images collected during delivery of the registered health care bundle comprises the selected object, wherein the feedback signal comprises at least one of: a corrective signal if the one or more images do not include the selected object associated with proper delivery of the registered health care bundle, and a confirmation signal if the one or more images include the selected object associated with proper delivery of the registered health care bundle; and

storing an indicator that is indicative of at least one selected object associated with proper delivery of the registered health care bundle found in the one or more images collected during delivery of the registered health care bundle.

17. A method according to embodiment 16, wherein the verification unit comprises a camera and an image processor, wherein the camera and the image processor are configured to collect images during delivery of the registered health care bundle and to process the collected images to determine if the one or more images comprise the selected object associated with proper delivery of the registered health care bundle.
18. A method according to embodiment 16, wherein the verification unit comprises a camera and an image processor, wherein the camera and the image processor are configured to transmit the one or more images collected during delivery of the registered health care bundle to a remote image processor, wherein the remote image processor is configured to process the collected images to determine if the one or more images comprise the selected object associated with proper delivery of the registered health care bundle.
19. A method according to embodiment 16, wherein a supplemental image collection device collects at least one image of the one or more images collected during delivery of the registered health care bundle.
20. A method according to embodiment 16, wherein the supplemental image collection device is selected from a group consisting of an ultrasonic imaging device, an imaging otoscope, a barcode scanner, a cell phone, and combinations thereof.
21. A method according to embodiment 16, wherein, if the delivery data collected during delivery of the registered health care bundle comprises a selected audio signature and a selected object, the method further comprises:

determining if the selected audio signature and the image comprising the selected object were collected in a selected order and/or within a selected period of time that is associated with proper delivery of the registered health care bundle;

providing a delivery feedback signal using the verification unit after determining if the selected audio signature and an image comprising the selected object were collected in the selected order and/or within the selected period of time, wherein the delivery feedback signal comprises at least one of: a confirmation signal if the selected audio signature and the image comprising the selected object were collected in the selected order and/or within the selected period of time that is associated with proper delivery of the registered health care bundle, and a corrective signal if the selected audio signature and the image comprising the selected object were not collected in the selected order and/or within the selected period of time that is associated with proper delivery of the registered health care bundle.

22. A method according to embodiment 16, wherein, if the delivery data collected during delivery of the registered health care bundle comprises a selected speech pattern and an image comprising a selected object, the method further comprises:

determining if the selected speech pattern and the image comprising the selected object were collected in a selected order and/or within a selected period of time that is associated with proper delivery of the registered health care bundle;

providing a delivery feedback signal using the verification unit after determining if the selected speech pattern and the image comprising the selected object were collected in the selected order and/or within the selected period of time, wherein the delivery feedback signal comprises at least one of: a confirmation signal if the selected speech pattern and the image comprising the selected object were collected in the selected order and/or within the selected period of time that is associated with proper delivery of the registered health care bundle, and a corrective signal if the selected speech pattern and the image comprising the selected object were not collected in the selected order and/or within the selected period of time that is associated with proper delivery of the registered health care bundle.

23. A method according to embodiment 16, wherein, if the delivery data collected during delivery of the registered health care bundle comprises a selected non-speech pattern and an image comprising a selected object, the method further comprises:

determining if the selected non-speech pattern and the image comprising the selected object were collected in a selected order and/or within a selected period of time that is associated with proper delivery of the registered health care bundle;

providing a delivery feedback signal using the verification unit after determining if the selected non-speech pattern and the image comprising the selected object were collected in the selected order and/or within the selected period of time, wherein the delivery feedback signal comprises at least one of:
a confirmation signal if the selected non-speech pattern and the image comprising the selected object were collected in the selected order and/or within the selected period of time that is associated with proper delivery of the registered health care bundle, and
a corrective signal if the selected non-speech pattern and the image comprising the selected object were not collected in the selected order and/or within the selected period of time that is associated with proper delivery of the registered health care bundle.
   24. A method according to either of embodiment 1 or 2, wherein registering the registered health care bundle to be delivered to the selected patient comprises:

collecting sound as a part of registering the health care bundle; and

determining if the sound collected as a part of registering the health care bundle comprises a selected speech pattern that is associated with identification of the health care bundle.

25. A method according to either of embodiment 1 or 2, wherein registering the health care bundle to be delivered to the selected patient comprises obtaining bundle data from a bundle credential associated with the selected health care bundle.
26. A method according to either of embodiment 1 or 2, wherein registering the health care bundle to be delivered to the selected patient comprises obtaining the bundle data associated with the selected health care bundle by scanning optical indicia on the bundle credential associated with the selected health care bundle.
27. A method according to either of embodiment 1 or 2, wherein registering the health care bundle to be delivered to the selected patient comprises obtaining an image associated with the selected health care bundle and determining if the image contains a selected object associated with identification of the selected health care bundle.
28. A method according to embodiment 2, wherein the method further comprises publishing selected information associated with the registered health care bundle using the verification unit.
29. A method according to embodiment 28, wherein the selected information comprises at least one instruction for delivering the registered health care bundle to the selected patient.
30. A method according to embodiment 28, wherein the selected information is stored in the verification unit before registering the health care bundle.
31. A method according to embodiment 28, wherein the selected information is delivered to the verification unit after registering the health care bundle.
32. A method of verifying delivery of a health care bundle to a patient, the method comprising:

registering a health care bundle to be delivered to a selected patient using a verification unit;

determining if the registered health care bundle should be delivered to the selected patient;

providing a registration feedback signal using the verification unit after determining if the registered health care bundle should be delivered to the selected patient, wherein the registration feedback signal comprises at least one of: a confirmation signal if the registered health care bundle should be delivered to the selected patient, and a corrective signal if the registered health care bundle should not be delivered to the selected patient;

collecting delivery data during delivery of the registered health care bundle to the selected patient, wherein the delivery data comprises one or more images associated with delivery of the registered health care bundle;

determining if the one or more images collected during delivery of the registered health care bundle comprise a selected object that is associated with proper delivery of the registered health care bundle;

providing a delivery feedback signal using the verification unit after determining if the one or more images collected during delivery of the registered health care bundle comprises the selected object, wherein the feedback signal comprises at least one of:
a corrective signal if the one or more images do not include the selected object associated with proper delivery of the registered health care bundle, and
a confirmation signal if the one or more images include the selected object associated with proper delivery of the registered health care bundle; and

storing an indicator that is indicative of at least one selected object associated with proper delivery of the registered health care bundle found in the one or more images collected during delivery of the registered health care bundle.

33. A method of verifying delivery of a health care bundle to a patient, the method comprising:

registering a health care bundle to be delivered to a selected patient;

publishing selected information associated with the registered health care bundle using a verification unit;

collecting delivery data during delivery of the registered health care bundle to the selected patient, wherein the delivery data comprises one or more images associated with delivery of the registered health care bundle;

determining if the one or more images collected during delivery of the registered health care bundle comprise a selected object that is associated with proper delivery of the registered health care bundle;

providing a delivery feedback signal using the verification unit after determining if the one or more images collected during delivery of the registered health care bundle comprises the selected object, wherein the feedback signal comprises at least one of:
a corrective signal if the one or more images do not include the selected object associated with proper delivery of the registered health care bundle, and
a confirmation signal if the one or more images include the selected object associated with proper delivery of the registered health care bundle; and

storing an indicator that is indicative of at least one selected object associated with proper delivery of the registered health care bundle found in the one or more images collected during delivery of the registered health care bundle.

34. A method according to either of embodiment 32 or 33, wherein the verification unit comprises a camera and an image processor, wherein the camera and the image processor are configured to collect images during delivery of the registered health care bundle and to process the collected images to determine if the one or more images comprise the selected object associated with proper delivery of the registered health care bundle.
35. A method according to either of embodiment 32 or 33, wherein the verification unit comprises a camera and an image processor, wherein the camera and the image processor are configured to transmit the one or more images collected during delivery of the registered health care bundle to a remote image processor, wherein the remote image processor is configured to process the collected images to determine if the one or more images comprise the selected object associated with proper delivery of the registered health care bundle.
36. A method according to either of embodiment 32 or 33, wherein a supplemental image collection device collects at least one image of the one or more images collected during delivery of the registered health care bundle.
37. A method according to embodiment 36, wherein the supplemental image collection device is selected from a group consisting of an ultrasonic imaging device, an imaging otoscope, a barcode scanner, a cell phone, and combinations thereof.
38. A method according to either of embodiment 32 or 33, wherein the stored indicator comprises text data associated with the selected object.
39. A method according to either of embodiment 32 or 33, wherein, if the one or more images collected during delivery of the registered health care bundle comprises a selected object, the stored indicator comprises at least a portion of the image that contains the selected object.
40. A method according to either of embodiment 32 or 33, wherein, if the one or more images collected during delivery of the registered health care bundle comprises a selected object, the stored indicator comprises a representative image associated with the selected object, wherein the representative image is not the image collected during delivery of the registered health care bundle.
41. A method according to either of embodiment 32 or 33, wherein, if the one or more images collected during delivery of the health care bundle comprise two images, each of which contains a selected object associated with proper delivery of the registered health care bundle, the method further comprises:

determining if the two images were collected in a selected order and/or within a selected period of time that is associated with proper delivery of the registered health care bundle;

providing a delivery feedback signal using the verification unit after determining if the two images were collected in the selected order and/or within the selected period of time, wherein the delivery feedback signal comprises at least one of:
a confirmation signal if the two images were collected in the selected order and/or within the selected period of time that is associated with proper delivery of the registered health care bundle; and
a corrective signal if the two images were not collected in the selected order and/or within the selected period of time that is associated with proper delivery of the registered health care bundle.
   42. A method according to either of embodiment 32 or 33, wherein registering the registered health care bundle to be delivered to the selected patient comprises:

collecting sound as a part of registering the health care bundle; and

determining if the sound collected as a part of registering the health care bundle comprises a selected speech pattern that is associated with identification of the health care bundle.

43. A method according to either of embodiment 32 or 33, wherein registering the health care bundle to be delivered to the selected patient comprises obtaining bundle data from a bundle credential associated with the selected health care bundle.
44. A method according to either of embodiment 32 or 33, wherein registering the health care bundle to be delivered to the selected patient comprises obtaining the bundle data associated with the selected health care bundle by scanning optical indicia on the bundle credential associated with the selected health care bundle.
45. A method according to either of embodiment 32 or 33, wherein registering the health care bundle to be delivered to the selected patient comprises obtaining an image associated with the selected health care bundle and determining if the image contains a selected object associated with identification of the selected health care bundle.
46. A method according to embodiment 33, wherein the method further comprises publishing selected information associated with the registered health care bundle using the verification unit.
47. A method according to embodiment 46, wherein the selected information comprises at least one instruction for delivering the registered health care bundle to the selected patient.
48. A method according to embodiment 46, wherein the selected information is stored in the verification unit before registering the health care bundle.
49. A method according to embodiment 46, wherein the selected information is delivered to the verification unit after registering the health care bundle.
50. A system for verifying delivery of a health care bundle to a patient, the system comprising:

a plurality of verification units operably connected to a central controller through a communication network in a health care facility, wherein each of the verification units comprises:

registration apparatus configured to register a health care bundle to be delivered to a selected patient;

feedback signal apparatus configured to deliver a feedback signal capable of detection by a person proximate the verification unit;

a delivery data collector configured to collect delivery data in the form of sound during delivery of a health care bundle;

wherein the system is configured to:
determine if the registered health care bundle should be delivered to the selected patient;
provide a registration feedback signal using the feedback signal apparatus of the verification unit after determining if the registered health care bundle should be delivered to the selected patient;
determine if sound collected by the verification unit comprises one or more selected audio signatures that are associated with proper delivery of the registered health care bundle, wherein each selected audio signature comprises either a selected speech pattern spoken during delivery of the registered health care bundle or a selected non-speech pattern collected during delivery of the registered health care bundle;
provide a delivery feedback signal using the feedback signal apparatus of the verification unit after determining if the sound comprises one or more of the selected audio signatures;
store an indicator that is indicative of at least one of any of the selected audio signatures found in the sound collected during delivery of the registered health care bundle.
   51. A system for verifying delivery of a health care bundle to a patient, the system comprising:

a plurality of verification units operably connected to a central controller through a communication network in a health care facility, wherein each of the verification units comprises:

publication apparatus configured to publish selected information associated with a registered health care bundle to a person proximate the verification unit;

feedback signal apparatus configured to deliver a feedback signal capable of detection by a person proximate the verification unit;

a delivery data collector configured to collect delivery data in the form of sound during delivery of a health care bundle;

wherein the system is configured to: determine if the registered health care bundle should be delivered to the selected patient; provide a registration feedback signal using the feedback signal apparatus of the verification unit after determining if the registered health care bundle should be delivered to the selected patient; determine if sound collected by the verification unit comprises one or more selected audio signatures that are associated with proper delivery of the registered health care bundle, wherein each selected audio signature comprises either a selected speech pattern spoken during delivery of the registered health care bundle or a selected non-speech pattern collected during delivery of the registered health care bundle; provide a delivery feedback signal using the feedback signal apparatus of the verification unit after determining if the sound comprises one or more of the selected audio signatures; store an indicator that is indicative of at least one of any of the selected audio signatures found in the sound collected during delivery of the registered health care bundle.

52. A system according to either of embodiment 50 or 51, wherein the feedback signal apparatus is configured to provide a feedback signal is selected from the group consisting of a visible signal, an audible signal, a tactile signal, and combinations of two or more thereof.
53. A system according to either of embodiment 50 or 51, wherein the verification unit comprises a microphone and an audio signal processor, wherein the microphone and the audio signal processor are configured to collect sound during delivery of the registered health care bundle and to process the collected sound to determine if the sound comprises the one or more selected audio signatures associated with proper delivery of the registered health care bundle.
54. A system according to either of embodiment 50 or 51:

wherein the central controller comprises a remote audio signal processor configured to process the sound collected by the verification unit to determine if the sound collected by the verification unit comprises the one or more selected audio signatures associated with proper delivery of the registered health care bundle;

wherein the verification unit comprises a microphone, an audio signal processor, and a communication device configured to transmit the sound collected by the verification unit during delivery of the registered health care bundle to the remote audio signal processor.

55. A system according to either of embodiment 50 or 51, wherein the system further comprises a supplemental audio collection device configured to collect at least a portion of the sound collected during delivery of the registered health care bundle.
56. A system according to embodiment 55, wherein the supplemental audio collection device comprises a stethoscope.
57. A system according to either of embodiment 50 or 51, wherein a selected non-speech pattern identified in the sound collected during delivery of the registered health care bundle comprises one or more of: sound produced by running water, sound produced when operating a hand sanitizer dispenser, sound in a frequency range above 20 kiloHertz, and sound produced when opening a selected package.
58. A system according to either of embodiment 50 or 51, wherein the stored indicator comprises text data.
59. A system according to either of embodiment 50 or 51, wherein, if a selected audio signature in the sound collected during delivery of the registered health care bundle comprises a selected speech pattern, the stored indicator comprises text data derived from the selected speech pattern.
60. A system according to either of embodiment 50 or 51, wherein, if the selected audio signature in the sound collected during delivery of the registered health care bundle comprises a selected non-speech pattern, the stored indicator comprises at least a portion of the sound collected by the verification unit that contains the selected non-speech pattern.
61. A system according to either of embodiment 50 or 51, wherein, if the selected audio signature in the sound collected during delivery of the registered health care bundle comprises a selected non-speech pattern, the stored indicator comprises a representative sound associated with the selected non-speech pattern, wherein the representative sound is not the sound collected during delivery of the registered health care bundle.
62. A system according to either of embodiment 50 or 51, wherein, if the one or more selected audio signatures in the sound collected during delivery of the health care bundle comprise two selected audio signatures, the system is configured to:

determine if the two selected audio signatures occur in a selected order and/or within a selected period of time that is associated with proper delivery of the registered health care bundle; and

provide a delivery feedback signal using the verification unit after determining if the two selected audio signatures occur in the selected order and/or within the selected period of time.

63. A system according to either of embodiment 50 or 51, wherein, if the one or more selected audio signatures in the sound collected during delivery of the health care bundle comprise two selected audio signatures that comprise a selected speech pattern and a selected non-speech pattern, the system is configured to: determine if the selected speech pattern and the selected non-speech pattern occur in a selected order and/or within a selected period of time that is associated with proper delivery of the registered health care bundle; and provide a delivery feedback signal using the verification unit after determining if the selected speech pattern and the selected non-speech pattern occur in the selected order and/or within the selected period of time.
64. A system according to either of embodiment 50 or 51, wherein, if one or more selected audio signatures in the sound collected during delivery of the health care bundle comprises two selected speech patterns, the system is configured to: determine if the two selected speech patterns occur in a selected order and/or within a selected period of time that is associated with proper delivery of the registered health care bundle; and provide a delivery feedback signal using the verification unit after determining if the two selected speech patterns occur in the selected order and/or within the selected period of time.
65. A system according to either of embodiment 50 or 51, wherein, if the one or more selected audio signatures in the sound collected during delivery of the health care bundle comprise two selected speech patterns and a selected non-speech pattern, the system is configured to: determine if the two selected speech patterns and the selected non-speech pattern occur in a selected order and/or within a selected period of time that is associated with proper delivery of the registered health care bundle; and provide a delivery feedback signal using the verification unit after determining if the two selected speech patterns and the selected non-speech pattern occur in the selected order and/or within the selected period of time.
66. A system according to either of embodiment 50 or 51, wherein the verification unit is configured to collect one or more images associated with delivery of the registered health care bundle; and wherein the system is configured to: determine if the one or more images collected during delivery of the registered health care bundle comprise a selected object that is associated with proper delivery of the registered health care bundle; provide a delivery feedback signal using the verification unit after determining if the one or more images collected during delivery of the registered health care bundle comprises the selected object; and store an indicator that is indicative of at least one selected object associated with proper delivery of the registered health care bundle found in the one or more images collected during delivery of the registered health care bundle.
67. A system according to embodiment 66, wherein the verification unit comprises a camera and an image processor, wherein the camera and the image processor configured to collect the images and to process the collected images to determine if the one or more images comprise the selected object associated with proper delivery of the registered health care bundle.
68. A system according to embodiment 66:

wherein the central controller comprises a remote image processor configured to process the images collected by the verification unit to determine if the one or more of the images collected by the verification unit comprise the selected object associated with proper delivery of the registered health care bundle; wherein the verification unit comprises a camera, an image processor, and a communication device configured to transmit images collected by the verification unit during delivery of the registered health care bundle to the remote image processor.

69. A system according to embodiment 66, wherein the system further comprises a supplemental image collection device configured to collect at least one image of the one or more images collected during delivery of the registered health care bundle.
70. A system according to embodiment 66, wherein the supplemental image collection device is selected from a group consisting of an ultrasonic imaging device, an imaging otoscope, a barcode scanner, a cell phone, and combinations thereof.
71. A system according to embodiment 66, wherein, if the delivery data collected during delivery of the registered health care bundle comprises a selected audio signature and a selected object, the system is configured to: determine if the selected audio signature and the image comprising the selected object were collected in a selected order and/or within a selected period of time that is associated with proper delivery of the registered health care bundle; provide a delivery feedback signal using the verification unit after determining if the selected audio signature and an image comprising the selected object were collected in the selected order and/or within the selected period of time.
72. A system according to embodiment 66, wherein, if the delivery data collected during delivery of the registered health care bundle comprises a selected speech pattern and an image comprising a selected object, the system is configured to: determine if the selected speech pattern and the image comprising the selected object were collected in a selected order and/or within a selected period of time that is associated with proper delivery of the registered health care bundle; provide a delivery feedback signal using the verification unit after determining if the selected speech pattern and the image comprising the selected object were collected in the selected order and/or within the selected period of time.
73. A system according to embodiment 66, wherein, if the delivery data collected during delivery of the registered health care bundle comprises a selected non-speech pattern and an image comprising a selected object, the system is configured to: determine if the selected non-speech pattern and the image comprising the selected object were collected in a selected order and/or within a selected period of time that is associated with proper delivery of the registered health care bundle; provide a delivery feedback signal using the verification unit after determining if the selected non-speech pattern and the image comprising the selected object were collected in the selected order and/or within the selected period of time.
74. A system according to embodiment 50, wherein registration apparatus of the verification unit is configured to collect sound as a part of registering the health care bundle; and wherein the system is configured to determine if the sound collected as a part of registering the health care bundle comprises a selected speech pattern that is associated with identification of the health care bundle.
75. A system according to embodiment 50, wherein the registration apparatus of the verification unit is configured to obtain bundle data from a bundle credential associated with the selected health care bundle.
76. A system according to embodiment 75, wherein the registration apparatus of the verification unit is configured to obtain the bundle data associated with the selected health care bundle by scanning optical indicia on the bundle credential associated with the selected health care bundle.
77. A system according to embodiment 50, wherein the registration apparatus of the verification unit is configured to obtain an image associated with the selected health care bundle; and wherein the system is configured to determine if the image contains a selected object associated with identification of the selected health care bundle.
78. A system according to embodiment 51, wherein the publication apparatus is configured to publish at least one instruction for delivering the registered health care bundle to the selected patient.
79. A system according to embodiment 51, wherein the selected information published by the publication apparatus is stored in the verification unit.
80. A system according to embodiment 51, wherein the selected information published by the publication apparatus is stored in the central controller and wherein the system is configured to deliver the selected information to the verification unit during delivery of the registered health care bundle.
81. A system for verifying delivery of a health care bundle to a patient, the system comprising: a plurality of verification units operably connected to a central controller through a communication network in a health care facility, wherein each of the verification units comprises: registration apparatus configured to register a health care bundle to be delivered to a selected patient; feedback signal apparatus configured to deliver a feedback signal capable of detection by a person proximate the verification unit; a delivery data collector configured to collect delivery data in the form of one or more images associated with delivery of the registered health care bundle during delivery of a health care bundle;

wherein the system is configured to:
determine if the registered health care bundle should be delivered to the selected patient; provide a registration feedback signal using the feedback signal apparatus of the verification unit after determining if the registered health care bundle should be delivered to the selected patient; determine if the one or more images collected during delivery of the registered health care bundle comprise a selected object that is associated with proper delivery of the registered health care bundle; provide a delivery feedback signal using the feedback signal apparatus of the verification unit after determining if the one or more images collected during delivery of the registered health care bundle comprises the selected object; and store an indicator that is indicative of a selected object associated with proper delivery of the registered health care bundle found in the one or more images collected during delivery of the registered health care bundle.
   82. A system for verifying delivery of a health care bundle to a patient, the system comprising:

a plurality of verification units operably connected to a central controller through a communication network in a health care facility, wherein each of the verification units comprises: publication apparatus configured to publish selected information associated with a registered health care bundle to a person proximate the verification unit; feedback signal apparatus configured to deliver a feedback signal capable of detection by a person proximate the verification unit; a delivery data collector configured to collect delivery data in the form of one or more images associated with delivery of the registered health care bundle during delivery of a health care bundle; wherein the system is configured to:
determine if the registered health care bundle should be delivered to the selected patient; provide a registration feedback signal using the feedback signal apparatus of the verification unit after determining if the registered health care bundle should be delivered to the selected patient; determine if the one or more images collected during delivery of the registered health care bundle comprise a selected object that is associated with proper delivery of the registered health care bundle; provide a delivery feedback signal using the feedback signal apparatus of the verification unit after determining if the one or more images collected during delivery of the registered health care bundle comprises the selected object; store an indicator that is indicative of a selected object associated with proper delivery of the registered health care bundle found in the one or more images collected during delivery of the registered health care bundle.
   83. A system according to either of embodiment 81 or 82, wherein the feedback signal apparatus is configured to provide a feedback signal is selected from the group consisting of a visible signal, an audible signal, a tactile signal, and combinations of two or more thereof.
   84. A system according to either of embodiment 81 or 82, wherein the verification unit comprises a camera and an image processor, wherein the camera and the image processor are configured to collect images during delivery of the registered health care bundle and to process the collected images to determine if the one or more images comprise the selected object associated with proper delivery of the registered health care bundle.
   85. A system according to either of embodiment 81 or 82:

wherein the central controller comprises a remote image processor configured to process the collected images to determine if the one or more images comprise the selected object associated with proper delivery of the registered health care bundle;

wherein the verification unit comprises a camera, an image processor, and a communication device configured to transmit the one or more images collected during delivery of the registered health care bundle to the remote image processor.

86. A system according to either of embodiment 81 or 82, wherein the system further comprises a supplemental image collection device configured to collect at least one image of the one or more images collected during delivery of the registered health care bundle.
87. A system according to either of embodiment 81 or 82, wherein the supplemental image collection device is selected from a group consisting of an ultrasonic imaging device, an imaging otoscope, a barcode scanner, a cell phone, and combinations thereof.
88. A system according to either of embodiment 81 or 82, wherein the stored indicator comprises text data associated with the selected object.
89. A system according to either of embodiment 81 or 82, wherein, if the one or more images collected during delivery of the registered health care bundle comprises a selected object, the stored indicator comprises at least a portion of the image that contains the selected object.
90. A system according to either of embodiment 81 or 82, wherein, if the one or more images collected during delivery of the registered health care bundle comprises a selected object, the stored indicator comprises a representative image associated with the selected object, wherein the representative image is not the image collected during delivery of the registered health care bundle.
91. A system according to either of embodiment 81 or 82, wherein, if the one or more images collected during delivery of the health care bundle comprise two images, each of which contains a selected object associated with proper delivery of the registered health care bundle, the system is configured to: determine if the two images were collected in a selected order and/or within a selected period of time that is associated with proper delivery of the registered health care bundle; and provide a delivery feedback signal using the verification unit after determining if the two images were collected in the selected order and/or within the selected period of time.
92. A system according to either of embodiment 81 or 82, wherein the registration apparatus of the verification unit is configured to collect sound as a part of registering the health care bundle; and wherein the system is configured to determine if the sound collected as a part of registering the health care bundle comprises a selected speech pattern that is associated with identification of the health care bundle.
93. A system according to embodiment 81, wherein the registration apparatus of the verification unit is configured to obtain bundle data from a bundle credential associated with the selected health care bundle.
94. A system according to embodiment 93, wherein the registration apparatus of the verification unit is configured to obtain the bundle data associated with the selected health care bundle by scanning optical indicia on the bundle credential associated with the selected health care bundle.
95. A system according to either of embodiment 81 or 82, wherein the registration apparatus of the verification unit is configured to obtain an image associated with the selected health care bundle; and wherein the system is configured to determine if the image contains a selected object associated with identification of the selected health care bundle.
96. A system according to embodiment 82, wherein the selected information published by the publication apparatus is stored in the verification unit.
97. A system according to embodiment 82, wherein the selected information published by the publication apparatus is stored in the central controller and wherein the system is configured to deliver the selected information to the verification unit during delivery of the registered health care bundle.

The complete disclosure of the patents, patent documents, and publications cited herein are incorporated by reference in their entirety as if each were individually incorporated.

Exemplary embodiments of methods, apparatus, and systems for verifying delivery of a health care bundle to a patient have been discussed and reference has been made to possible variations. These and other variations and modifications will be apparent to those skilled in the art without departing from the scope of the invention, and it should be understood that the invention is not limited to the illustrative embodiments set forth herein. Accordingly, the invention is to be limited only by the embodiments provided below and equivalents thereof.

1. A method of verifying delivery of a health care bundle to a patient, the method comprising:
registering a health care bundle to be delivered to a selected patient using a verification unit;
determining if the registered health care bundle should be delivered to the selected patient;
providing a registration feedback signal using the verification unit after determining if the registered health care bundle should be delivered to the selected patient, wherein the registration feedback signal comprises at least one of:
a confirmation signal if the registered health care bundle should be delivered to the selected patient, and
a corrective signal if the registered health care bundle should not be delivered to the selected patient;
collecting delivery data during delivery of the registered health care bundle to the selected patient;
determining if the data collected during delivery of the registered health care bundle comprises one or more selected features that are associated with proper delivery of the registered health care bundle;
providing a delivery feedback signal using the verification unit after determining if the data comprises the one or more selected features, wherein the feedback signal comprises at least one of:
a corrective signal if the data does not include at least one selected features associated with proper delivery of the registered health care bundle, and
a confirmation signal if the data includes at least one selected feature associated with proper delivery of the registered health care bundle; and
storing an indicator that is indicative of at least one of the selected features found in the data collected during delivery of the registered health care bundle.

2. (canceled)

3. A method according to claim 1, wherein the verification unit comprises a data collection device and a signal processor, wherein the data collection device and the signal processor are configured to transmit the data collected during delivery of the registered health care bundle to a remote signal processor, wherein the remote signal processor is configured to process the data collected by the verification unit to determine if the data comprises the one or more selected features associated with proper delivery of the registered health care bundle.

4. A method according to claim 1, wherein the stored indicator comprises text data associated with the selected feature.

5-6. (canceled)

7. A method according to claim 1, wherein, if the one or more selected features in the data collected during delivery of the health care bundle comprise two selected features, the method further comprises:
determining if the two selected features occur in a selected order and/or within a selected period of time that is associated with proper delivery of the registered health care bundle;
providing a delivery feedback signal using the verification unit after determining if the two selected features occur in the selected order and/or within the selected period of time, wherein the delivery feedback signal comprises at least one of:
a confirmation signal if the two selected features occur in the selected order and/or within the selected period of time that is associated with proper delivery of the registered health care bundle; and
a corrective signal if the two selected features do not occur in the selected order and/or within the selected period of time that is associated with proper delivery of the registered health care bundle.

8. The method of claim 1, wherein the delivery data comprises sound, one or more images, or combinations thereof, associated with the delivery of the registered health care bundle, wherein if the delivery data comprises sound, the selected features comprises one or more selected audio signatures, wherein if the delivery data comprises one or more images, the selected features comprises one or more objects, and wherein the one or more images comprises at least one of still image and video.

9. The method of claim 8, wherein the delivery data comprises sound associated with delivery of the registered health care bundle, wherein selected features comprises one or more selected audio signatures, and wherein each selected audio signature comprises either a selected speech pattern spoken during delivery of the registered health care bundle or a selected non-speech pattern collected during delivery of the registered health care bundle.

10. A method according to claim 9, wherein a selected non-speech pattern identified in the sound collected during delivery of the registered health care bundle comprises one or more of: sound produced by running water, sound produced when operating a hand sanitizer dispenser, sound in a frequency range above 20 kilo Hertz, and sound produced when opening a selected package.

11-12. (canceled)

13. A method according to claim 1, wherein the method further comprises publishing selected information associated with the registered health care bundle using the verification unit.

14. (canceled)

15. The method of claim 1, wherein registering the health care bundle to be delivered to the selected patient comprises obtaining bundle data from a bundle credential associated with the selected health care bundle.

16. A method according to claim 1, wherein a supplemental collection device collects at least one features of the one or more selected features collected during delivery of the registered health care bundle, and wherein the supplemental collection device is selected from a group consisting of an ultrasonic imaging device, an imaging otoscope, a barcode scanner, a cell phone, a stethoscope, and combinations thereof.

17. A method of verifying delivery of a health care bundle to a patient, the method comprising:
registering a health care bundle to be delivered to a selected patient using a verification unit;
determining if the registered health care bundle should be delivered to the selected patient;
providing a registration feedback signal using the verification unit after determining if the registered health care bundle should be delivered to the selected patient, wherein the registration feedback signal comprises at least one of:
a confirmation signal if the registered health care bundle should be delivered to the selected patient, and
a corrective signal if the registered health care bundle should not be delivered to the selected patient;
collecting sound during delivery of the registered health care bundle to the selected patient, the sound associated with delivery of the registered health care bundle;
collecting one or more images associated with delivery of the registered health care bundle;
determining if the sound collected during delivery of the registered health care bundle comprises one or more selected audio signatures that are associated with proper delivery of the registered health care bundle, wherein each selected audio signature comprises either a selected speech pattern spoken during delivery of the registered health care bundle or a selected non-speech pattern collected during delivery of the registered health care bundle;
determining if the one or more images collected during delivery of the registered health care bundle comprise a selected object that is associated with proper delivery of the registered health care bundle;
providing a delivery feedback signal using the verification unit after determining if the sound comprises the one or more selected audio signatures, wherein the feedback signal comprises at least one of: a corrective signal if the sound does not include at least one selected audio signature associated with proper delivery of the registered health care bundle, and a confirmation signal if the sound includes at least one selected audio signature associated with proper delivery of the registered health care bundle;
providing a delivery feedback signal using the verification unit after determining if the one or more images collected during delivery of the registered health care bundle comprises the selected object, wherein the feedback signal comprises at least one of: a corrective signal if the one or more images do not include the selected object associated with proper delivery of the registered health care bundle, and a confirmation signal if the one or more images include the selected object associated with proper delivery of the registered health care bundle;
storing an indicator that is indicative of at least one of the selected audio signatures found in the sound collected during delivery of the registered health care bundle; and
storing an indicator that is indicative of at least one selected object associated with proper delivery of the registered health care bundle found in the one or more images collected during delivery of the registered health care bundle.

18. A method according to claim 17, wherein, if the delivery data collected during delivery of the registered health care bundle comprises a selected audio signature and a selected object, the method further comprises:
determining if the selected audio signature and the image comprising the selected object were collected in a selected order and/or within a selected period of time that is associated with proper delivery of the registered health care bundle;
providing a delivery feedback signal using the verification unit after determining if the selected audio signature and an image comprising the selected object were collected in the selected order and/or within the selected period of time, wherein the delivery feedback signal comprises at least one of:
a confirmation signal if the selected audio signature and the image comprising the selected object were collected in the selected order and/or within the selected period of time that is associated with proper delivery of the registered health care bundle, and
a corrective signal if the selected audio signature and the image comprising the selected object were not collected in the selected order and/or within the selected period of time that is associated with proper delivery of the registered health care bundle.

19-20. (canceled)

21. A system for verifying delivery of a health care bundle to a patient, the system comprising:
a plurality of verification units operably connected to a central controller through a communication network in a health care facility, wherein each of the verification units comprises:
registration apparatus configured to register a health care bundle to be delivered to a selected patient;
feedback signal apparatus configured to deliver a feedback signal capable of detection by a person proximate the verification unit;
a delivery data collector configured to collect delivery data during delivery of a health care bundle;
wherein the system is configured to:
determine if the registered health care bundle should be delivered to the selected patient;
provide a registration feedback signal using the feedback signal apparatus of the verification unit after determining if the registered health care bundle should be delivered to the selected patient;
determine if data collected by the verification unit comprises one or more selected features that are associated with proper delivery of the registered health care bundle;
provide a delivery feedback signal using the feedback signal apparatus of the verification unit after determining if the data comprises one or more of the selected features;
store an indicator that is indicative of at least one of any of the selected features found in the data collected during delivery of the registered health care bundle.

22. (canceled)

23. A system according to claim 21, wherein the verification unit comprises a data collection device and a signal processor, wherein the data collection device and the processor are configured to collect data during delivery of the registered health care bundle and to process the collected data to determine if the data comprises the one or more selected features associated with proper delivery of the registered health care bundle.

24. A system according to claim 21, wherein, if the one or more selected features in the data collected during delivery of the health care bundle comprise two selected features, the system is configured to:
determine if the two selected features occur in a selected order and/or within a selected period of time that is associated with proper delivery of the registered health care bundle; and
provide a delivery feedback signal using the verification unit after determining if the two selected features occur in the selected order and/or within the selected period of time.

25. The method of claim 24, wherein the delivery data comprises sound associated with delivery of the registered health care bundle, wherein selected features comprises one or more selected audio signatures, and wherein each selected audio signature comprises either a selected speech pattern spoken during delivery of the registered health care bundle or a selected non-speech pattern collected during delivery of the registered health care bundle.

26. A system according to claim 25, wherein, if the selected audio signature in the sound collected during delivery of the registered health care bundle comprises a selected non-speech pattern, the stored indicator comprises a representative sound associated with the selected non-speech pattern, wherein the representative sound is not the sound collected during delivery of the registered health care bundle.

27. A system according to claim 21, wherein the delivery data comprises one or more images associated with delivery of the registered health care bundle, and wherein the selected feature comprises one or more objects.

28. A system according to claim 21, wherein the system further comprises publication apparatus configured to publish selected information associated with a registered health care bundle to a person proximate the verification unit.

29. A system according to claim 28, wherein the selected information comprises at least one instruction for delivering the registered health care bundle to the selected patient.
